(19) United States
(12) Patent Application Publication
(10) Pub. No.: US 2009/0233198 A1
(43) Pub. Date: Sep. 17, 2009

(54) PHOTOCURABLE COMPOSITION, OVERPRINT, AND PRODUCTION PROCESS THEREFOR

(75) Inventor: Ryuki KAKINO, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/402,201

(22) Filed: Mar. 11, 2009

(30) Foreign Application Priority Data
Mar. 13, 2008 (JP) 2008-063634

(51) Int. Cl. G03G 5/06; G03G 5/00

(52) U.S. Cl. 430/66; 430/132; 430/70; 430/75

(57) ABSTRACT

A process for producing an overprint is provided that includes a step of preparing a printed material by printing on a printing substrate, a step of coating the printed material with a photocurable composition, and a step of photocuring the photocurable composition,
the photocurable composition including (1) a bridged ring hydrocarbon group-containing cationically polymerizable compound and (2) a photo-acid generator. There is also provided an overprint produced by the process. Furthermore, there is provided a photocurable composition that includes (1) a bridged ring hydrocarbon group-containing cationically polymerizable compound and (2) a photo-acid generator.

### BACKGROUND OF THE INVENTION

1. Field of the Invention

The present invention relates to a photocurable composition, and to an overprint and a process for producing same. More particularly, the present invention relates to a photocurable coating composition that is curable upon exposure to actinic radiation such as an electron beam or UV rays. In particular, it relates to a photocurable coating composition for coating an image formed by depositing ink and/or toner on a printing substrate (image receiving substrate) by a method such as lithography, relief printing, intaglio printing, screen printing, inkjet, or electrophotography. More particularly, it relates to a photocurable overprint composition (overprint composition) particularly suitably used for coating a toner-based printed material printed by an electrophotographic process.

2. Description of the Related Art

In recent years, photocurable compositions, in particular UV curable compositions, have been used in a large number of applications. Examples of the photocurable compositions include printing inks, overcoat varnishes, paints, adhesives, and photoresists.

In particular, a printed material in which an overprint coating is applied on top of toner-based image information such as in an electrophotographic method so as to improve protection of a printed material and give surface gloss has been commercialized as an alternative product to a silver halide photographic print and is attracting attention.

In the electrophotographic method, which gives a toner-based printed material, an electrostatic charge is formed on the surface of a latent image-retaining body, for example, a photoreceptor, by uniformly charging the surface of the latent image-retaining body.

Subsequently, charge on the uniformly charged region is selectively released by a pattern of activation irradiation corresponding to an original image. The latent image charge pattern remaining on the surface corresponds to regions that have not been exposed to radiation. Subsequently, the photoreceptor is passed through one or a plurality of development housings containing toner, and since the toner is deposited on the charge pattern by electrostatic attractive force, the latent image charge pattern is visualized. Subsequently, the developed image is either fixed on an image-forming surface or transferred to a printing substrate such as, for example, paper and fixed thereto by an appropriate fixation technique, thus giving an electrophotographically printed material, that is, a toner-based printed material.

As a known method for protecting a printed material, applying an overprint coating to the printed material has been proposed. For example, JP-A-11-70647 and JP-A-2003-241414 (JP-A denotes a Japanese unexamined patent application publication) propose a method such as an electrophotographic process, in which fixation is carried out after a transparent toner is transferred on top of a toner-based image, thus covering the surface.

Furthermore, JP-A-61-210365 proposes a method in which an overprint coating is applied by applying a liquid film coating that is curable by UV rays, etc. and polymerizing (crosslinking) a coating component by means of light.

Furthermore, JP-A-2005-321782 discloses an overprint composition comprising a radiation curable oligomer selected from the group consisting of trifunctional unsaturated acrylic resins, a radiation curable monomer selected from the group consisting of polyfunctional alkoxylated acrylic monomers and polyalkoxylated acrylic monomers, such as one type or a plurality of types of diacrylate or triacrylate, at least one type of photopolymerization initiator, and at least one type of surfactant.

JP-A-2003-12661 discloses a process for producing a 3-alkoxymethyloxetane compound, the process comprising carrying out a first reaction in which a 3-hydroxymethyloxetane compound and an organic sulfonyl halide are reacted in the presence of an organic base in a state in which a hydrohalide salt of the organic base formed during the reaction is dissolved, thus forming a 3-halomethyloxetane compound, and subsequently carrying out a second reaction in which the 3-halomethyloxetane compound and an alcohol are reacted under the addition of an alkali as a solid or a nonaqueous solution, thus forming a 3-alkoxymethyloxetane compound. JP-A-2008-13646 discloses an ink composition comprising a compound containing a cyclic ether partial structure having at least one bicyclo ring or tricyclo ring substituent.

### BRIEF SUMMARY OF THE INVENTION

It is an object of the present invention to provide a photocurable composition giving excellent surface smoothness, non-tackiness (suppression of surface tackiness), and suppression of odor, an overprint obtained by using the photocurable composition, and a process for producing same.

The above object has been attained by (1) to (17).

(1). A process for producing an overprint, the process comprising: a step of preparing a printed material by printing on a printing substrate; a step of coating the printed material with a photocurable composition; and a step of photocuring the photocurable composition; the photocurable composition comprising (1) a bridged ring hydrocarbon group-containing cationically polymerizable compound and (2) a photo-acid generator,
(2). The process for producing an overprint according to (1), wherein the cationically polymerizable compound comprises an epoxy group, an oxetanyl group, or a vinyl ether group,
(3). The process for producing an overprint according to (1), wherein the bridged ring hydrocarbon group is a bicyclo ring or a tricyclo ring,
(4). The process for producing an overprint according to (1), wherein the cationically polymerizable compound is a compound in which the bridged ring hydrocarbon group and a cationically polymerizable group are bonded via a divalent linking group, and the divalent linking group is a group selected from the group consisting of a single bond, an alkylene group having 1 to 6 carbon atoms, an ether bond, a carbonyl group, a carboxylic acid ester bond, and a group that is formed by combining the above,
(5). The process for producing an overprint according to (1), wherein the photocurable composition comprises, in addition to the cationically polymerizable compound, at least one compound selected from the group consisting of an epoxy compound, an oxetane compound, and a vinyl ether compound that do not have a bridged ring hydrocarbon group,
(6). The process for producing an overprint according to (1), wherein the photocurable composition has substantially no absorption in the visible region,
(7). The process for producing an overprint according to (1), wherein the printing is electrophotographic printing, and the printed material is an electrophotographically printed material,
(8). The process for producing an overprint according to (7), wherein the electrophotographically printed material is an electrophotographically printed material having a fuser oil layer,
(9). The process for producing an overprint according to (1), wherein the amount of cured photocurable composition formed on the printed material is 1 to 10 g/m²,
(10). The process for producing an overprint according to (1), wherein the photocurable composition cured on the printed material has a thickness of 1 to 10 μm,
(11). An overprint produced by the process for producing an overprint according to (1),
(12). A photocurable composition comprising: (1) a bridged ring hydrocarbon group-containing cationically polymerizable compound; and (2) a photo-acid generator,
(13). The photocurable composition according to (12), wherein the cationically polymerizable compound comprises an epoxy group, an oxetanyl group, or a vinyl ether group,
(14). The photocurable composition according to (12), wherein the bridged hydrocarbon group is a bicyclo ring or a tricyclo ring,
(15). The photocurable composition according to (12), wherein the cationically polymerizable compound is a compound in which the bridged hydrocarbon group and a cationically polymerizable group are bonded via a divalent linking group, and the divalent linking group is a group selected from the group consisting of a single bond, an alkylene group having 1 to 6 carbon atoms, an ether bond, a carbonyl group, a carboxylic acid ester bond, and a group that is formed by combining the above,
(16). The photocurable composition according to (12), wherein the photocurable composition comprises, in addition to the cationically polymerizable compound, at least one compound selected from the group consisting of an epoxy compound, an oxetane compound, and a vinyl ether compound that do not have a bridged ring hydrocarbon group,
(17). The photocurable composition according to (12), wherein it has substantially no absorption in the visible region.

### DETAILED DESCRIPTION OF THE INVENTION

### Photocurable Composition

The photocurable composition of the present invention (hereinafter, also called a ‘photocurable coating composition’, a ‘photocurable overprint composition’, or simply a ‘coating composition’) comprises (1) a bridged ring hydrocarbon group-containing cationically polymerizable compound and (2) a photo-acid generator. The present invention is explained in detail below.

When a fuser oil layer is present on an image surface in a toner-based image such as in an electrophotographic method, since the surface of a printed material is hydrophobic and the surface energy is low, it is currently difficult to obtain a photocurable composition that satisfies all of curability, surface smoothness, strength, storage stability, etc.

Furthermore, in particular, when an overprint coating is applied onto toner-based image information to thus serve as an alternative product to a silver halide photographic print, since a consumer handles it directly, odor and product safety are counted as important product qualities.

As a cause of the occurrence of an odor, there can be cited a residual volatile compound such as a polymerizable monomer (uncured monomer), a decomposition product of a polymerization initiator that is not incorporated into a cured coating due to lack of copolymerizability with a curable composition, etc. With regard to suppression of odor due to the polymerizable monomer, from the viewpoint of low volatility, use of a solid monomer or a high molecular weight liquid monomer can be considered, but since the viscosity of the polymerizable composition increases, the surface smoothness deteriorates, thus causing the problem of lines, etc. occurring on the surface of a printed material.

The present inventors have found that, in accordance with the use of a photocurable coating composition comprising a bridged ring hydrocarbon group-containing cationically polymerizable compound and a photo-acid generator, an overprint that is excellent in terms of surface smoothness, non-tackiness (suppression of surface tackiness), and suppression of odor can be provided.

The bridged ring hydrocarbon group-containing cationically polymerizable compound in the present invention is a compound that initiates a polymerization reaction and cures by means of an acid generated from a compound (photo-acid generator), which is described later, that generates an acid as a result of irradiation with radiation.

That is, the photocurable coating composition of the present invention is a composition that can be cured upon exposure to actinic radiation. The ‘actinic radiation’ referred to in the present invention is not particularly limited as long as it is actinic radiation that can provide energy that enables an initiating species to be generated in the composition when irradiated, and broadly includes α rays, γ rays, X rays, ultraviolet rays, visible light, and an electron beam; among these, ultraviolet rays and an electron beam are preferable from the viewpoint of curing sensitivity and the availability of equipment, and ultraviolet rays are particularly preferable. The photocurable coating composition of the present invention is preferably an photocurable coating composition that can be cured upon exposure to ultraviolet rays as radiation.

The photocurable coating composition of the present invention preferably has substantially no absorption in the visible region. ‘Having substantially no absorption in the visible region’ means either having no absorption in a visible region of 400 to 700 nm or having only a level of absorption in the visible region that does not cause any problem as a photocurable coating composition. Specifically, a 5 μm optical path length transmittance of the coating composition in a wavelength region of 400 to 700 nm is at least 70%, and preferably at least 80%.

The photocurable coating composition of the present invention may suitably be used as one for an overprint, and may particularly suitably be used as one for an overprint for an electrophotographically printed material. When the photocurable coating composition of the present invention is used for forming an overprint layer on an electrophotographically printed material having an image area with a thickness of a toner, an overprint with excellent non-tackiness and surface smoothness and having luster and gloss can be obtained, and an impression that it is visually close to a conventional silver halide photographic print can be given. Furthermore, when the photocurable coating composition of the present invention is used for a toner image having a layer of fuser oil on the image surface, an image-printed material that has excellent non-tackiness and surface smoothness, has luster and gloss, has little distortion, and is highly flexible can be given, and an overprint that is visually close to a silver halide photographic print can be obtained.

### (1) Bridged Ring Hydrocarbon Group-Containing Cationically Polymerizable Compound

The photocurable coating composition of the present invention comprises a bridged ring hydrocarbon group-containing cationically polymerizable compound (hereinafter, also called simply a ‘specific polymerizable compound’).

### (A) Bridged Ring Hydrocarbon Group

The specific polymerizable compound has at least one bridged ring hydrocarbon group in the molecule. The bridged ring hydrocarbon group means one formed by removing at least one hydrogen atom from a bridged ring hydrocarbon. The bridged ring hydrocarbon may be a saturated hydrocarbon or an unsaturated hydrocarbon.

With regard to the bridged ring hydrocarbon, atoms forming a ring in this structure are not particularly limited, but a ring formed from oxygen or carbon is preferable, and a ring formed from carbon atoms is more preferable.

The number of carbon atoms forming the ring of the bridged ring hydrocarbon is preferably 6 to 18, and more preferably 7 to 12.

The specific polymerizable compound may have at least one bridged ring hydrocarbon group per molecule, preferably 1 or 2, and more preferably 1.

Among the bridged ring hydrocarbons, a bicyclo ring, a tricyclo ring, or a tetracyclo ring is preferable, and a bicyclo ring or a tricyclo ring is more preferable.

In the present invention, the bicyclo ring means one that requires two scissions of bonds between ring atoms before reaching an open-chain structure having no ring, and the tricyclo ring means one that requires three scissions of bonds between ring atoms before reaching an open-chain structure having no ring.

As a bridged ring hydrocarbon constituting the bridged ring hydrocarbon group that can preferably be used in the present invention, those below can be cited, but the present invention should not be construed as being limited thereto.

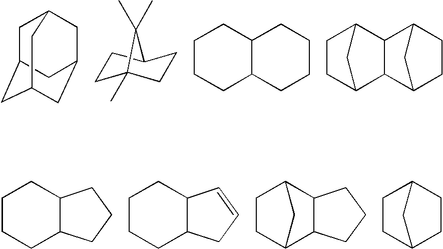

### (B) Cationically Polymerizable Group

The bridged ring hydrocarbon group-containing cationically polymerizable compound comprises, as a partial structure, at least one cationically polymerizable group. Among cationically polymerizable groups, preferred examples of the polymerizable group include a cyclic ether group and a vinyl ether group, and a cyclic ether group is more preferable.

In particular, a preferred cyclic ether group is a 3- or higher-membered ring, and a more preferred cyclic ether group is a 3- to 8-membered ring. Furthermore, the number of oxygen atoms constituting the ring of the cyclic ether is preferably one or two, and more preferably one.

In the present invention, from the viewpoint of cationic polymerizability, the cationically polymerizable group is preferably a group formed by removing at least one hydrogen atom from the cyclic ethers shown below.

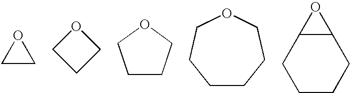

In particular, from the viewpoint of reactivity, the cyclic ether group is preferably an epoxy group, an alicyclic epoxy group, or an oxetanyl group, which have 3 to 4 ring members, and an oxetanyl group is more preferable. The cyclic ether group may be monocyclic or polycyclic.

Furthermore, as a preferred cationically polymerizable group other than a cyclic ether, a vinyl ether group can be cited.

The number of cationically polymerizable groups contained per molecule is at least one, preferably 1 to 4, more preferably 1 or 2, and yet more preferably 1.

### (C) Linking Group

The bridged ring hydrocarbon group (A) and the cationically polymerizable group (B) may be bonded directly or via any polyvalent linking group, and from the viewpoint of the physical properties and effects of the photocurable coating composition it is preferable that the bridged ring hydrocarbon group (A) and the cationically polymerizable group (B) are in the vicinity of each other. From such a viewpoint, even when they are bonded via a linking group, the number of atoms constituting the main skeleton of the linking group is preferably no greater than 6, and more preferably in the range of 1 to 4.

The ‘number of atoms constituting the main skeleton’ referred to in the present invention means the number of atoms, used only for linking the bridged ring hydrocarbon group (A) and the cationically polymerizable group (B), of the linking group linking them.

As the polyvalent linking group there can be cited a linking group comprising a linking block such as —O—, —CH₂—, or —C(O)—, and a polyvalent linking group that is formed by bonding two or more of these linking blocks via any combination of bonds.

Specifically, the polyvalent linking group is preferably a divalent linking group selected from the group consisting of a single bond, an alkylene group having 1 to 6 carbon atoms, an ether bond (—O—), a carbonyl group (—C(O)—), a carboxylic acid ester bond (—C(O)O— or —OC(O)—), and a linking group formed by combining the above, and more preferably comprises at least one ether bond or ester bond.

### (D) Substituent

The bridged ring hydrocarbon group-containing cationically polymerizable compound may have a substituent at a substitutable position. Examples of substituents that can be introduced include an alkyl group having 1 to 18 carbon atoms, a cycloalkyl group having 3 to 12 carbon atoms, an aryl group having 6 to 14 carbon atoms, an alkoxy group having 1 to 18 carbon atoms, an aryloxy group having 6 to 10 carbon atoms, an alkylamino group having 1 to 18 carbon atoms, and an arylamino group having 6 to 10 carbon atoms.

### (E) Specific Examples

Representative specific examples of the specific polymerizable compound in the present invention are listed below, but the present invention should not be construed as being limited to these specific examples.

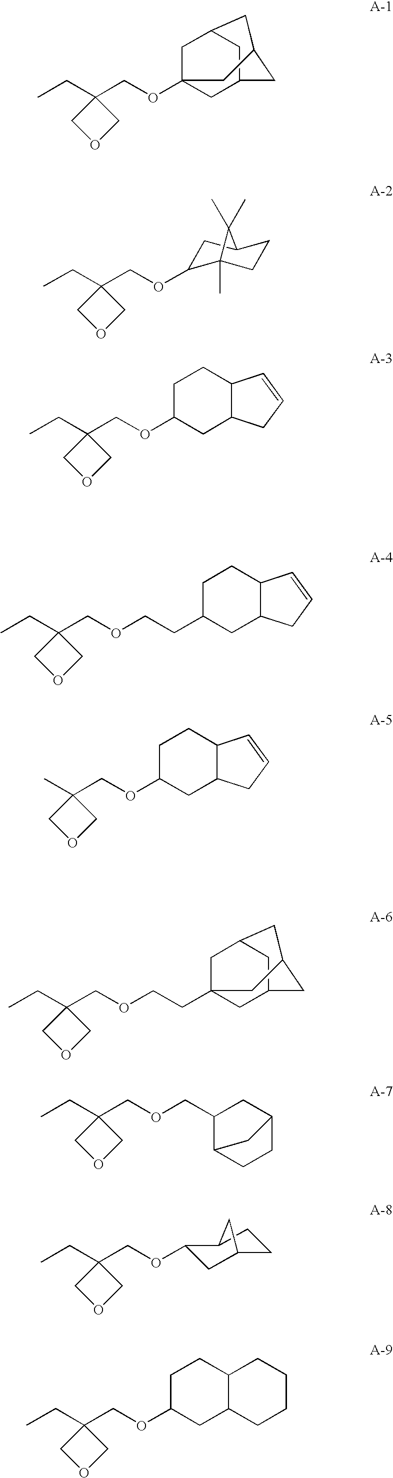

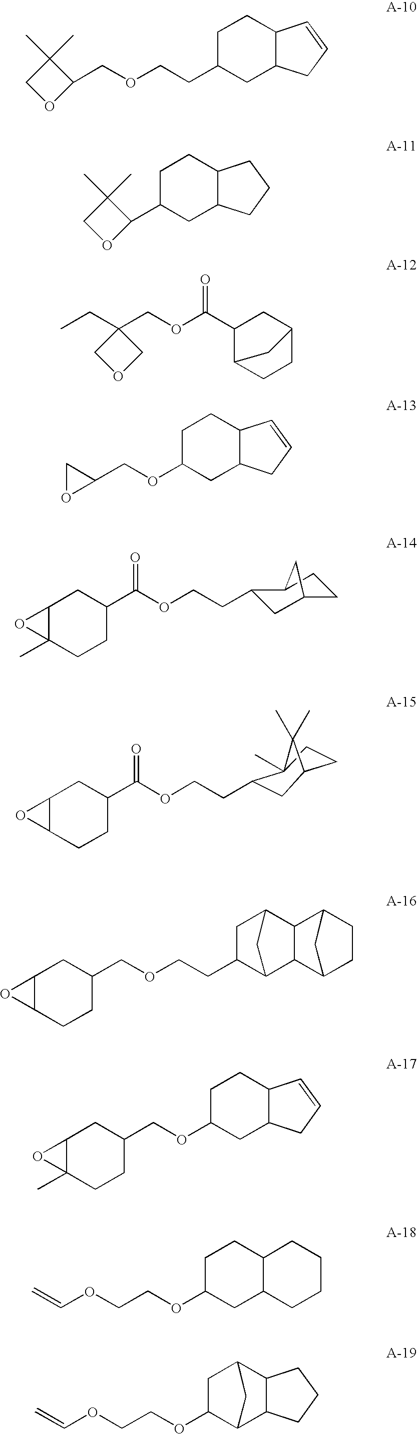

### Synthesis of Bridged Ring Hydrocarbon Group-Containing Cationically Polymerizable Compound

The bridged ring hydrocarbon group-containing cationically polymerizable compound in the present invention may be synthesized by, for example, the following method.

Any starting material may be used as long as a cyclic ether compound can be produced by a method due to Motoi (Motoi et al., Bull. Chem. Soc. Jpn., 61, 1998), which is a dehydrohalogenation reaction, or a similar desulfonation reaction.

Specifically, the specific polymerizable compound may be produced by an etherification reaction of a cyclic ether compound having a sulfonic acid ester structure or a halide, represented by Formula (II) below, and an alcohol having the above bridged ring hydrocarbon group.

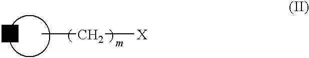

In Formula (II), X denotes a leaving group such as a halogen atom or a sulfonic acid ester group, and m denotes an integer of 1 or more.

Cases in which the cyclic ether group is an oxetanyl group are explained below as an example, but the compound used in the present invention is not limited to an oxetane compound.

Examples of halogenated or sulfonic acid esterified oxetane compounds represented by Formula (II) include 3-chloromethyl-3-methyloxetane, 3-bromoethyl-3-ethyloxetane, 3-methyl-3-iodopropyloxetane, 3-ethyl-3-methylsulfonyloxymethyloxetane, 3-chloromethyl-3-ethyloxetane, 3-ethyl-3-bromopropyloxetane, 3-chloromethyl-3-propyloxetane, 3-bromoethyl-3-propyloxetane, and 3-bromopropyl-3-propyloxetane; one type thereof may be used on its own, or two or more types thereof may be used in combination.

Specific examples of the bridged ring hydrocarbon group-containing alcohol compound include 1-adamantanol, borneol, decahydro-2-naphthol, hydroxydicyclopentadiene, and isoborneol.

Furthermore, the reaction ratio of the cyclic ether compound having a halide or sulfonic acid ester structure and the bridged ring hydrocarbon group-containing alcohol compound is not particularly limited, but it is preferable that the halogenated or sulfonic acid esterified oxetane compound represented by Formula (II) is reacted in the range of 0.05 to 0.6 mol per mol of the bridged ring hydrocarbon group-containing alcohol compound, and more preferably in the range of 0.2 to 0.5 mol.

The reaction temperature when producing the specific polymerizable compound is now explained. The reaction temperature for reacting the above-mentioned two components is determined while taking into consideration the yield of the specific polymerizable compound, etc., and from the viewpoint of improvement of the reactivity between starting material compounds and the yield, and the degree of freedom in selecting an organic solvent that can be used, the temperature is preferably in the range of 0° C. to 100° C., more preferably in the range of 10° C. to 90° C., and yet more preferably in the range of 20° C. to 80° C.

The reaction time when producing the specific polymerizable compound is now explained. The reaction time is determined while taking into consideration the yield of the specific polymerizable compound, the reaction temperature, etc. and, for example, when the reaction temperature is in the range of 0° C. to 100° C., which is a preferred reaction temperature range, the reaction time is preferably in the range of 10 minutes to 100 hours. When in this reaction time range, it is possible to suppress residual unreacted starting materials and achieve high productivity. The reaction time when producing the specific polymerizable compound is preferably in the range of 30 minutes to 50 hours, and more preferably in the range of 1 to 10 hours.

The reaction atmosphere (pH) when producing the specific polymerizable compound is now explained. The reaction atmosphere (pH value) is determined while taking into consideration the yield of the specific polymerizable compound, etc., but from the viewpoint of suppression of side reactions and the degree of freedom in selecting starting materials used it is preferably in the range of, for example, 5 to 14. The pH value when producing the specific polymerizable compound is more preferably in the range of 6 to 14, and yet more preferably in the range of 7 to 14. In order to adjust the pH value to a value in such a range, it is preferable to add an alkali such as sodium hydroxide, potassium hydroxide, or potassium t-butoxide.

A phase transfer catalyst used when producing the specific polymerizable compound is now explained. In order to improve the reactivity between the bridged ring hydrocarbon group-containing alcohol compound and the compound represented by Formula (II), it is preferable to add a phase transfer catalyst during the reaction. With regard to the amount thereof added, from the viewpoint of effects exhibited by the addition, such as improvement of reactivity and yield, and ease of purification of the specific polymerizable compound obtained, when, for example, the total amount of starting materials is 100 parts by weight, the amount of phase transfer catalyst added is preferably a value in the range of 0.1 to 30 parts by weight, more preferably a value in the range of 1.0 to 20.0 parts by weight, and yet more preferably a value in the range of 2.0 to 10.0 parts by weight.

Furthermore, the type of phase transfer catalyst is not particularly limited and, for example, it is preferably at least one type of compound selected from the group consisting of a quaternary ammonium salt compound and a quaternary phosphonium salt compound.

Specific examples thereof include tetra-n-butylammonium bromide, tetramethylammonium bromide, benzyltriethylammonium bromide, hexadecyltrimethylammonium bromide, triethylhexadecylammonium bromide, trioctylmethylammonium bromide, methyltriphenylphosphonium bromide, triethylhexadecylphosphonium bromide, tetraphenylphosphonium bromide, and tetrabutylphosphonium bromide; one type thereof may be used on its own, or two or more types thereof may be used in combination.

An organic solvent used when reacting the bridged ring hydrocarbon group-containing alcohol compound and the compound represented by Formula (II) is now explained. It is preferable for such an organic solvent to be a good solvent toward starting materials and, from the viewpoint of ease of production, to be a liquid having a boiling point at atmospheric pressure of no greater than 250° C.

Examples of such an organic solvent include hydrocarbons such as hexane, heptane, and octane, halohydrocarbons such as dichloromethane and chloroform, ethers such as diethyl ether, dibutyl ether, ethylene glycol dimethyl ether, tetrahydrofuran, and dioxane, ketones such as acetone, methyl ethyl ketone, methyl isobutyl ketone, and cyclohexanone, esters such as ethyl acetate, butyl acetate, amyl acetate, and γ-butyrolactone, aromatic hydrocarbons such as benzene, toluene, and xylene, and aprotic polar solvents such as N,N-dimethylsulfoxide (DMSO), N,N-dimethylformamide (DMF), and dimethylacetamide (DMA); one type thereof may be used on its own, or two or more types thereof may be used in combination.

The structure of the specific polymerizable compound obtained by the above-mentioned production process may be confirmed by ¹H-NMR and IR spectra.

With regard to the specific polymerizable compound, one type thereof may be used on its own, or two or more types thereof may be used in combination. The content of the specific polymerizable compound in the photocurable coating composition of the present invention is, relative to the total solids content of the photocurable coating composition, preferably 1 to 90 wt %, more preferably 5 to 85 wt %, yet more preferably 30 to 80 wt %, and particularly preferably 50 to 80 wt %.

When within the above-mentioned range of values, a photocurable coating composition that cures with high sensitivity can be obtained, and by photocuring the photocurable coating composition, an overprint layer having excellent non-tackiness (suppression of surface tackiness) and excellent surface smoothness due to the viscosity of the photocurable coating composition being appropriate can be obtained.

This specific polymerizable compound is a compound that is a solid at normal temperature or has a viscosity of 5 to 200 mPa·s, has excellent crystallinity, and gives excellent film properties after curing; when it is added to the photocurable coating composition it is preferable for it to be present together with a low viscosity liquid polymerizable compound or an appropriate solvent, and from the viewpoint of curability, it is preferable for it to be used together with a polymerizable compound that is a liquid at normal temperature and has a low viscosity.

The photocurable coating composition of the present invention may employ another polymerizable compound (cationically polymerizable compound), which will be described in detail later, in combination with the specific polymerizable compound in an amount that does not impair the effects of the present invention.

As hereinbefore described, when as the specific polymerizable compound one that is a solid at normal temperature or is a liquid having relatively high viscosity is used, it is preferable for it to be present together with, as a diluent, a polymerizable compound (particularly preferably a polymerizable monomer) that is a liquid at normal temperature and has a low viscosity.

Furthermore, from the viewpoint of effective suppression of shrinkage when curing the photocurable coating composition, it is preferable to use in combination the specific polymerizable compound and, as the other polymerizable compound, at least one type of compound selected from an epoxy compound, an oxetane compound, and a vinyl ether compound, which are explained below.

### Other Cationically Polymerizable Compound

The other cationically polymerizable compound that can be used in combination with the specific polymerizable compound in the present invention is not particularly limited as long as it is a compound for which a polymerization reaction is initiated and which is cured by means of an acid generated from a compound (photo-acid generator), which is described later, that generates an acid as a result of irradiation with radiation, and various cationically polymerizable monomers known as cationically photopolymerizable monomers may be used.

Examples of the other cationically polymerizable monomer include epoxy compounds, oxetane compounds, vinyl ether compounds, not corresponding to the specific polymerizable compound, described in JP-A-6-9714, JP-A-2001-31892, JP-A-2001-40068, JP-A-2001-55507, JP-A-2001-310938, JP-A-2001-310937, JP-A-2001-220526, etc.

Examples of the epoxy compounds include aromatic epoxides, alicyclic epoxides, and aliphatic epoxides.

Examples of the aromatic epoxide include di- or polyglycidyl ethers produced by a reaction between epichlorohydrin and a polyhydric phenol having at least one aromatic nucleus or an alkylene oxide adduct thereof; specific examples include di- or polyglycidyl ethers of bisphenol A or an alkylene oxide adduct thereof, di- or polyglycidyl ethers of hydrogenated bisphenol A or an alkylene oxide adduct thereof, and novolac type epoxy resins. Examples of the alkylene oxide above include ethylene oxide and propylene oxide.

Examples of the alicyclic epoxides include cyclohexene oxide- and cyclopentene oxide-containing compounds obtained by epoxidizing a compound having at least one cycloalkene ring such as a cyclohexene ring or a cyclopentene ring with an appropriate oxidizing agent such as hydrogen peroxide or a peracid.

Examples of the aliphatic epoxides include di- or polyglycidyl ethers of an aliphatic polyhydric alcohol or an alkylene oxide adduct thereof, and representative examples thereof include diglycidyl ethers of an alkylene glycol such as the diglycidyl ether of ethylene glycol, the diglycidyl ether of propylene glycol, and the diglycidyl ether of 1,6-hexanediol, polyglycidyl ethers of a polyhydric alcohol such as the di- or triglycidyl ether of glycerol or an alkylene oxide adduct thereof, and diglycidyl ethers of a polyalkylene glycol such as the diglycidyl ether of polyethylene glycol or an alkylene oxide adduct thereof and the diglycidyl ether of polypropylene glycol or an alkylene oxide adduct thereof. Examples of the alkylene oxide above include ethylene oxide and propylene oxide.

Detailed examples of monofunctional and polyfunctional epoxy compounds that can be used in the present invention are now given.

Examples of monofunctional epoxy compounds include phenyl glycidyl ether, p-tert-butylphenyl glycidyl ether, butyl glycidyl ether, 2-ethylhexyl glycidyl ether, allyl glycidyl ether, 1,2-butylene oxide, 1,3-butadiene monooxide, 1,2-epoxydodecane, epichlorohydrin, 1,2-epoxydecane, styrene oxide, cyclohexene oxide, 3-methacryloyloxymethylcyclohexene oxide, 3-acryloyloxymethylcyclohexene oxide, and 3-vinylcyclohexene oxide.

Furthermore, examples of polyfunctional epoxy compounds include bisphenol A diglycidyl ether, bisphenol F diglycidyl ether, bisphenol S diglycidyl ether, brominated bisphenol A diglycidyl ether, brominated bisphenol F diglycidyl ether, brominated bisphenol S diglycidyl ether, epoxy novolac resins, hydrogenated bisphenol A diglycidyl ether, hydrogenated bisphenol F diglycidyl ether, hydrogenated bisphenol S diglycidyl ether, 3,4-epoxycyclohexenylmethyl-3′,4′-epoxycyclohexenecarboxylate, bis(3,4-epoxycyclohexylmethyl) adipate, vinylcyclohexene oxide, 4-vinylepoxycyclohexane, bis(3,4-epoxy-6-methylcyclohexylmethyl) adipate, 3,4-epoxy-6-methylcyclohexenyl 3′,4′-epoxy-6′-methylcyclohexenecarboxylate, methylenebis(3,4-epoxycyclohexane), dicyclopentadiene diepoxide, the di(3,4-epoxycyclohexylmethyl)ether of ethylene glycol, ethylene bis(3,4-epoxycyclohexanecarboxylate), dioctyl epoxyhexahydrophthalate, di-2-ethylhexyl epoxyhexahydrophthalate, 1,4-butanediol diglycidyl ether, 1,6-hexanediol diglycidyl ether, glycerol triglycidyl ether, trimethylolpropane triglycidyl ether, polyethylene glycol diglycidyl ether, polypropylene glycol diglycidyl ether, 1,13-tetradecadiene dioxide, limonene dioxide, 1,2,7,8-diepoxyoctane, and 1,2,5,6-diepoxycyclooctane.

Among these epoxy compounds, the aromatic epoxides and the alicyclic epoxides are preferable from the viewpoint of excellent curing speed, and the alicyclic epoxides are particularly preferable.

Examples of the vinyl ether compounds include di- or tri-vinyl ether compounds such as ethylene glycol divinyl ether, diethylene glycol divinyl ether, triethylene glycol divinyl ether, propylene glycol divinyl ether, dipropylene glycol divinyl ether, butanediol divinyl ether, hexanediol divinyl ether, cyclohexanedimethanol divinyl ether, and trimethylolpropane trivinyl ether, and monovinyl ether compounds such as ethyl vinyl ether, n-butyl vinyl ether, isobutyl vinyl ether, octadecyl vinyl ether, cyclohexyl vinyl ether, hydroxybutyl vinyl ether, 2-ethylhexyl vinyl ether, cyclohexanedimethanol monovinyl ether, n-propyl vinyl ether, isopropyl vinyl ether, isopropenyl vinyl ether, dodecyl vinyl ether, and diethylene glycol monovinyl ether.

Detailed examples of monofunctional vinyl ethers and polyfunctional vinyl ethers are given below.

Examples of monofunctional vinyl ethers include methyl vinyl ether, ethyl vinyl ether, propyl vinyl ether, n-butyl vinyl ether, t-butyl vinyl ether, 2-ethylhexyl vinyl ether, n-nonyl vinyl ether, lauryl vinyl ether, cyclohexyl vinyl ether, cyclohexylmethyl vinyl ether, 4-methylcyclohexylmethyl vinyl ether, benzyl vinyl ether, methoxyethyl vinyl ether, ethoxyethyl vinyl ether, butoxyethyl vinyl ether, methoxyethoxyethyl vinyl ether, ethoxyethoxyethyl vinyl ether, methoxypolyethylene glycol vinyl ether, tetrahydrofurfuryl vinyl ether, 2-hydroxyethyl vinyl ether, 2-hydroxypropyl vinyl ether, 4-hydroxybutyl vinyl ether, 4-hydroxymethylcyclohexylmethyl vinyl ether, diethylene glycol monovinyl ether, polyethylene glycol vinyl ether, chloroethyl vinyl ether, chlorobutyl vinyl ether, chloroethoxyethyl vinyl ether, phenylethyl vinyl ether, and phenoxypolyethylene glycol vinyl ether.

Furthermore, examples of polyfunctional vinyl ethers include divinyl ethers such as ethylene glycol divinyl ether, diethylene glycol divinyl ether, polyethylene glycol divinyl ether, propylene glycol divinyl ether, butylene glycol divinyl ether, hexanediol divinyl ether, bisphenol A alkylene oxide divinyl ether, and bisphenol F alkylene oxide divinyl ether; and polyfunctional vinyl ethers such as trimethylolethane trivinyl ether, trimethylolpropane trivinyl ether, ditrimethylolpropane tetravinyl ether, glycerol trivinyl ether, pentaerythritol tetravinyl ether, dipentaerythritol pentavinyl ether, dipentaerythritol hexavinyl ether, an ethylene oxide adduct of trimethylolpropane trivinyl ether, a propylene oxide adduct of trimethylolpropane trivinyl ether, an ethylene oxide adduct of ditrimethylolpropane tetravinyl ether, a propylene oxide adduct of ditrimethylolpropane tetravinyl ether, an ethylene oxide adduct of pentaerythritol tetravinyl ether, a propylene oxide adduct of pentaerythritol tetravinyl ether, an ethylene oxide adduct of dipentaerythritol hexavinyl ether, and a propylene oxide adduct of dipentaerythritol hexavinyl ether.

As the vinyl ether compound, the di- or tri-vinyl ether compounds are preferable from the viewpoint of curability, adhesion to a recording medium, surface hardness of the image formed, etc., and the divinyl ether compounds are particularly preferable.

The other oxetane compound that can be used in combination with the specific polymerizable compound in the present invention may be selected freely from known oxetane compounds such as those described in JP-A-2001-220526, JP-A-2001-310937, and JP-A-2003-341217. As the compound having an oxetane ring that can be used with the specific polymerizable compound in the present invention, a compound having 1 to 4 oxetane rings in the structure is preferable. In accordance with use of such a compound, it becomes easy to maintain the viscosity of the photocurable coating composition in a range that gives good handling properties and, furthermore, when the compound is used in the photocurable coating composition, the cured photocurable coating composition can be given high adhesion to the printed material, which is preferable.

Examples of compounds that can be used in combination with the specific polymerizable compound in the present invention having 1 to 2 oxetane rings in the molecule include compounds represented by Formulae (1) to (3) below.

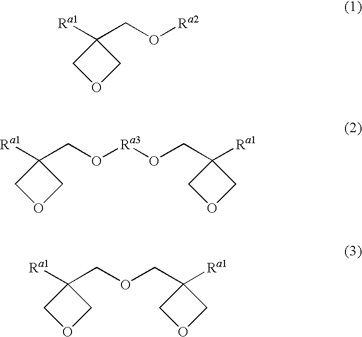

R^{a1} denotes a hydrogen atom, an alkyl group having 1 to 6 carbon atoms, a fluoroalkyl group having 1 to 6 carbon atoms, an allyl group, an aryl group, a furyl group, or a thienyl group. When there are two R^{a1} in the molecule, they may be identical to or different from each other.

Examples of the alkyl group include a methyl group, an ethyl group, a propyl group, and a butyl group, and preferred examples of the fluoroalkyl group include those obtained by substituting any of the hydrogen atoms of the above alkyl groups with a fluorine atom.

R^{a2} denotes a hydrogen atom, an alkyl group having 1 to 6 carbon atoms, an alkenyl group having 2 to 6 carbon atoms, a group having an aromatic ring having no more than 20 carbon atoms, an alkylcarbonyl group having 2 to 6 carbon atoms, an alkoxycarbonyl group having 2 to 6 carbon atoms, or an N-alkylcarbamoyl group having 2 to 6 carbon atoms. Examples of the alkyl group include a methyl group, an ethyl group, a propyl group, and a butyl group, examples of the alkenyl group include a 1-propenyl group, a 2-propenyl group, a 2-methyl-1-propenyl group, a 2-methyl-2-propenyl group, a 1-butenyl group, a 2-butenyl group, and a 3-butenyl group, and examples of the group having an aromatic ring include a phenyl group, a benzyl group, a fluorobenzyl group, a methoxybenzyl group, and a phenoxyethyl group. Examples of the alkylcarbonyl group include an ethylcarbonyl group, a propylcarbonyl group, and a butylcarbonyl group, examples of the alkoxycarbonyl group include an ethoxycarbonyl group, a propoxycarbonyl group, and a butoxycarbonyl group, and examples of the N-alkylcarbamoyl group include an ethylcarbamoyl group, a propylcarbamoyl group, a butylcarbamoyl group, and a pentylcarbamoyl group. Furthermore, R^{a2} may have a substituent, and the substituent include an alkyl group having 1 to 6 carbon atoms and a fluorine atom.

R^{a3} denotes a linear or branched alkylene group having 1 to 10 carbon atoms, a linear or branched unsaturated hydrocarbon group having 1 to 10 carbon atoms, a carbonyl group or a carbonyl group-containing alkylene group having 1 to 10 carbon atoms, a carboxyl group-containing alkylene group having 1 to 10 atoms, a carbamoyl group-containing alkylene group having 1 to 10 atoms, a alkylene oxy group having 1 to 6 containing poly (alkylene oxy) group or polyvalent group shown below. Examples of the alkylene group include an ethylene group, a propylene group, and a butylene group, and examples of the poly(alkyleneoxy) group include a poly(ethyleneoxy) group and a poly(propyleneoxy) group. Examples of the unsaturated hydrocarbon group include a propenylene group, a methylpropenylene group, and a butenylene group.

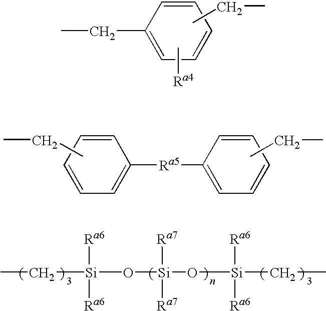

When R^{a3} is the above-mentioned polyvalent group, R^{a4} denotes a hydrogen atom, an alkyl group having 1 to 4 carbon atoms, an alkoxy group having 1 to 4 carbon atoms, a halogen atom, a nitro group, a cyano group, a mercapto group, a lower alkylcarboxyl group, a carboxyl group, or a carbamoyl group.

R^{a5} denotes an oxygen atom, a sulfur atom, a methylene group, NH, SO, SO₂, C(CF₃)₂, or, C(CH₃)₂.

R^{a6} denotes an alkyl group having 1 to 4 carbon atoms or an aryl group having not greater than 20 carbon atoms, and n is an integer of 0 to 2,000. R^{a7} denotes an alkyl group having 1 to 4 carbon atoms, an aryl group having not greater than 20 carbon atoms, or a monovalent group having the structure below. In the formula, R^{a8} denotes an alkyl group having 1 to 4 carbon atoms or an aryl group having not greater than 20 carbon atoms, and m is an integer of 0 to 100.

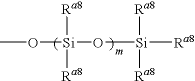

Examples of compounds represented by Formula (1) include 3-ethyl-3-hydroxymethyloxetane (OXT-101: Toagosei Co., Ltd.), 3-ethyl-3-(2-ethylhexyloxymethyl)oxetane (OXT-212: Toagosei Co., Ltd.), and 3-ethyl-3-phenoxymethyloxetane (OXT-211: Toagosei Co., Ltd.). Examples of compounds represented by Formula (2) include 1,4-bis[(3-ethyl-3-oxetanylmethoxy)methyl]benzene (OXT-121: Toagosei Co., Ltd.). Examples of compounds represented by Formula (3) include bis(3-ethyl-3-oxetanylmethyl)ether (OXT-221: Toagosei Co., Ltd.).

Examples of the compound having 3 to 4 oxetane rings in the molecule include compounds represented by Formula (4) below.

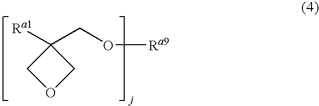

In Formula (4), R^{a1} denotes the same as in Formula (1) above. Furthermore, examples of R^{a9}, which is a polyvalent linking group, include a branched alkylene group having 1 to 12 carbon atoms such as a group represented by A to C below, a branched poly(alkyleneoxy) group such as a group represented by D below, and a branched polysiloxane group such as a group represented by E below. j is 3 or 4.

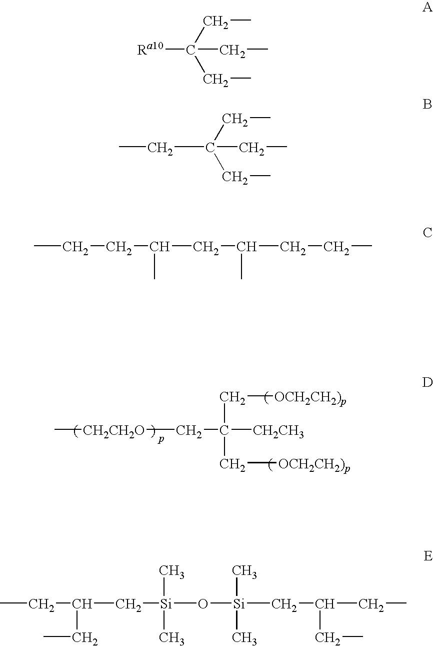

In the above A, R^{a10} denotes a methyl group, an ethyl group, or a propyl group. Furthermore, in the above D, p is an integer of 1 to 10.

In the present invention, the photocurable composition preferably comprises an epoxy compound and/or an oxetane compound in addition to the bridged ring hydrocarbon group-containing cationically polymerizable compound (1) above.

In the present invention, the content of the cationically polymerizable compound other than the specific polymerizable compound is preferably no greater than 70 wt % of the solids content of the photocurable coating composition, more preferably no greater than 60 wt %, and yet more preferably no greater than 50 wt %. When within the above-mentioned range of values, a high sensitivity photocurable coating composition is obtained, and an overcoat layer formed by photocuring such a photocurable coating composition has excellent non-tackiness and excellent surface smoothness due to it having an appropriate viscosity.

Furthermore, when a polyvalent cationically polymerizable compound is contained, it is preferably no greater than 30 wt % of the solids content of the photocurable coating composition, and more preferably no greater than 20 wt %.

Furthermore, when the specific polymerizable compound and the other cationically polymerizable compound are used in combination in the present invention, the proportion of the other cationically polymerizable compound is preferably no greater than 70 wt % of the weight of all the polymerizable compounds, that is, the total of the specific polymerizable compound and the other cationically polymerizable compound, and is more preferably 20 to 60 wt %. When within the above-mentioned range of values, a high sensitivity photocurable coating composition is obtained, and an overcoat layer formed by photocuring such a photocurable coating composition has excellent non-tackiness and excellent surface smoothness due to it having an appropriate viscosity.

### (2) Photo-Acid Generator

The photocurable coating composition of the present invention comprises a photo-acid generator. In the present invention, an acid generated by irradiation with radiation causes a polymerization reaction of the cationically polymerizable compound, and the photocurable coating composition thereby cures.

As the photo-acid generator, a cationic photopolymerization photoinitiator, a radical photopolymerization photoinitiator, a photo-decolorizing agent or a photo-discoloring agent for a dye, or a compound that generates an acid when exposed to light used in a microresist, etc. (ultraviolet light at 200 to 400 nm, far ultraviolet light, particularly preferably, g-line, h-line, i-line, KrF excimer laser light), ArF excimer laser light, an electron beam, X rays, a molecular beam, or an ion beam, may be used by appropriately selecting therefrom.

Examples of such a photo-acid generator include onium salt compounds such as diazonium salts, phosphonium salts, sulfonium salts, and iodonium salts, and sulfonate compounds such as imidosulfonates, oxime sulfonates, diazodisulfones, disulfones, and o-nitrobenzylsulfonates, which generate an acid by decomposition when exposed to radiation.

Other specific examples of the compound that generates an acid when exposed to actinic light or radiation, which can be used in the present invention, include diazonium salts disclosed in, for instance, S. I. Schlesinger, Photogr. Sci. Eng., 1974, 18:387 and T. S. Bal et al., Polymer, 1980, 21:423; ammonium salts disclosed in, for instance, U.S. Pat. Nos. 4,069,055, 4,069,056 and JP-A-3-140140; phosphonium salts disclosed in, for instance, D. C. Necker et al., Macromolecules, 1984, 17:2468, C. S. Wen et al., The Proc. Conf. Rad. Curing ASIA, p. 478, Tokyo, October (1988) and U.S. Pat. Nos. 4,069,055 and 4,069,056; iodonium salts disclosed in, for instance, J. V. Crivello et al., Macromolecules, 10 (6), 1307 (1977), Chem. Eng. News, November 28, p. 31 (1988), European Patent No. 104,143, 339,049, 410,201, JP-A-2-150848 and JP-A-2-296514; sulfonium salts disclosed in, for instance, J. V. Crivello et al., Polymer J., 1985, 17:73, J. V. Crivello et al., J. Org. Chem., 1978, 43:3055, W. R. Watt et al., J. Polymer Sci., Polymer Chem. Ed., 1984, 22:1789, J. V. Crivello et al., Polymer Bull., 1985, 14:279, J. V. Crivello et al., Macromolecules, 14(5), 1141 (1981), J. V. Crivello et al., J. Polymer Sci., Polymer Chem. Ed., 1979, 17:2877, European Patent Nos. 370,693, 161,811, 410,201, 339,049, 233,567, 297,443 and 297,442, U.S. Pat. Nos. 3,902,114, 4,933,377, 4,760,013, 4,734,444 and 2,833,827 and German Patent Nos. 2,904,626, 3,604,580 and 3,604,581, JP-A-7-28237, and JP-A-8-27102; selenonium salts disclosed in, for instance, J. V. Crivello et al., Macromolecules, 10(6), 1307 (1977) and J. V. Crivello et al., J. Polymer Sci., Polymer Chem. Ed., 1979, 17:1047; onium salts such as arsonium salts disclosed in, for instance, C. S. Wen et al., The Proc. Conf. Rad. Curing ASIA, p. 478, Tokyo, October (1988); organic halogen-containing compounds disclosed in, for instance, U.S. Pat. No. 3,905,815, JP-B-46-4605, JP-A-48-36281, JP-A-55-32070, JP-A-60-239736, JP-A-61-169835, JP-A-61-169837, JP-A-62-58241, JP-A-62-212401, JP-A-63-70243 and JP-A-63-298339; organometallic/organic halogen-containing compounds disclosed in, for instance, K. Meier et al., J. Rad. Curing, 13(4), 26 (1986), T. P. Gill et al., Inorg. Chem., 1980, 19:3007, D. Astruc, Acc. Chem. Res., 19(12), 377 (1986) and JP-A-2-161445; photo-acid generators comprising o-nitrobenzyl type protecting group disclosed in, for instance, S. Hayase et al., J. Polymer Sci., 1987, 25:753, E. Reichmanis et al., J. Polymer Sci., Polymer Chem. Ed., 1985, 23:1, Q. Q. Zhu et al., J. Photochem., 36, 85, 39, 317 (1987), B. Amit et al., Tetrahedron Lett., (24), 2205 (1973), D. H. R. Barton et al., J. Chem. Soc., 3571 (1965), P. M. Collins et al., J. Chem. Soc., Perkin 1, 1695 (1975), M. Rudinstein et al., Tetrahedron Lett., (17), 1445 (1975), J. W. Walker et al., J. Am. Chem. Soc., 110, 7170 (1988), S. C. Busman et al., J. Imaging Technol., 11(4), 191 (1985), H. M. Houlihan et al., Macromolecules, 21, 2001 (1988), P. M. Collins et al., J. Chem. Soc., Chem. Commun., 532 (1972), S. Hayase et al., Macromolecules, 18, 1799 (1985), E. Reichmanis et al., J. Electrochem. Soc., Solid State Sci. Technol., 130(6), F. M. Houlihan et al., Macromolecules, 21, 2001 (1988), European Patent Nos. 0,290,750, 046,083, 156,535, 271,851 and 0,388,343, U.S. Pat. Nos. 3,901,710 and 4,181,531 and JP-A-60-198538 and JP-A-53-133022; compounds producing sulfonic acids by photolysis which are represented by iminosulfonates described in M. Tunooka et al., Polymer Preprints Japan, 35 (8), G. Berner et al., J. Rad. Curing, 13 (4), W. J. Mijs et al., Coating Technol., 55 (697), 45 (1983), Akzo, H. Adachi et al., Polymer Preprints Japan, 37 (3), European Patents 0,199,672, 84,515, 044,115, 618,564, and 0,101,122, U.S. Pat. Nos. 4,371,605 and 4,431,774, JP-A-64-18143, JP-A-2-245756 and JP-A-3-140109; and disulfone compounds described in JP-A-61-166544 and JP-A-2-71270; and diazoketosulfone and diazodisulfone compounds described in JP-A-3-103854, JP-A-3-103856, and JP-A-4-210960.

Further, compounds in which these photo-acid generating groups or compounds are introduced into their main chains or side chains can be used. Examples of such compounds are described in M. E. Woodhouse et al., J. Am. Chem. Soc., 104, 5586 (1982), S. P. Pappas et al., J. Imaging Sci., 30 (5), 218 (1986), S. Kondo et al., Makromol. Chem., Rapid Commun., 9, 625 (1988), Y. Yamada et al., Makromol. Chem., 152, 153, 163 (1972), J. V. Crivello et al., J. Polymer Sci., Polymer Chem. Ed., 17, 3845 (1979), U.S. Pat. No. 3,849,137, German Patent 3,914,407, JP-A-63-26653, JP-A-55-164824, JP-A-62-69263, JP-A-63-146038, JP-A-63-163452, JP-A-62-153853 and JP-A-63-146029. Examples thereof include onium salt compounds such as diazonium salts, ammonium salts, phosphonium salts, iodonium salts, sulfonium salts, selenonium salts, and arsonium salts; organic halogen compounds; organometallic/organohalides; photo-acid generators having an o-nitrobenzyl type protecting group; compounds that generate a sulfonic acid by photodecomposition, represented by iminosulfonates; disulfone compounds; diazoketosulfones; and diazodisulfone compounds.

Further, there can also be used compounds that generate an acid with light which are described in V. N. R. Pillai, Synthesis, (1) 1 (1980), A. Abad et al., Tetrahedron Lett., (47), 4555 (1971), D. H. R. Barton et al., J. Chem. Soc., (C), 329 (1970), U.S. Pat. No. 3,779,778 and European Patent No. 126,712.

Preferred examples of the photo-acid generator that can be used in the present invention include compounds represented by Formulae (b1), (b2), and (b3) below.

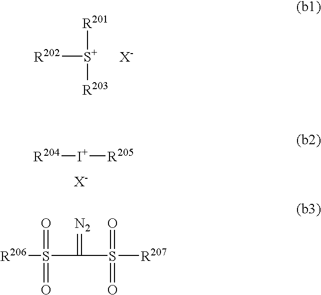

In Formula (b1), R²⁰¹, R²⁰², and R²⁰³ independently denote an organic group.

X⁻ denotes a non-nucleophilic anion; preferred examples thereof include a sulfonic acid anion, a carboxylic acid anion, a bis(alkylsulfonyl)amide anion, a tris(alkylsulfonyl)methide anion, BF₄⁻, PF₆⁻, SbF₆⁻, and anions shown below, and an organic anion having a carbon atom is preferable.

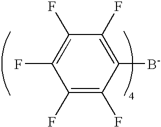

Preferred examples of the organic anion include organic anions represented by the formulae below.

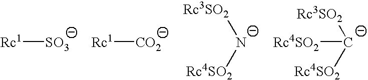

Rc¹ denotes an organic group.

Examples of the organic group denoted by Rc¹ include those having 1 to 30 carbon atoms, and preferred examples thereof include an alkyl group having 1 to 20 carbon atoms, a cycloalkyl group having 1 to 20 carbon atoms, an aryl group having no greater than 20 carbon atoms, and a group formed by connecting a plurality of the above groups via a linking group such as a single bond, —O—, —CO₂—, —S—, —SO₃—, or —SO₂N(Rd¹)—.

Rd¹ denotes a hydrogen atom or an alkyl group having 1 to 10 carbon atoms.

Rc³, Rc⁴, and Rc⁵ independently denote an organic group.

With regard to the organic groups denoted by Rc³, Rc⁴, and Rc⁵, those cited as preferred examples for the organic group denoted by Rc¹ are cited here, and a perfluoroalkyl group having 1 to 4 carbon atoms is most preferable.

Rc³ and Rc⁴ may be bonded to form a ring.

Examples of a group formed by bonding of Rc³ and Rc⁴ include an alkylene group having 1 to 10 carbon atoms and an arylene group having no greater than 20 carbon atoms. It is preferably a perfluoroalkylene group having 2 to 4 carbon atoms.

The most preferred examples of the organic groups denoted by Rc¹, and Rc³ to Rc⁵, include an alkyl group having 1 to 10 carbon atoms whose 1 position has been substituted with a fluorine atom or a fluoroalkyl group, and a phenyl group substituted with a fluorine atom or a fluoroalkyl group. Introducing a fluorine atom or a fluoroalkyl group increases the acidity of an acid generated on exposure to light, thus improving the sensitivity.

In the Formula (b1), the number of carbon atoms of the organic groups denoted by R²⁰¹, R²⁰², and R²⁰³ is preferably 1 to 30, and more preferably 1 to 20.

Furthermore, two of R²⁰¹ to R²⁰³ may be bonded to form a ring structure, and an oxygen atom, a sulfur atom, an ester bond, an amide bond, or a carbonyl group may be contained in the ring. Examples of the group formed by bonding of two of R²⁰¹ to R²⁰³ include alkylene groups having 1 to 10 carbon atoms (e.g. a butylene group and a pentylene group).

Specific examples of the organic groups denoted by R²⁰¹, R²⁰², and R²⁰³ are the corresponding groups in compounds (b1-1), (b1-2), and (b1-3), which will be described later.

The photo-acid generator may be a compound having a plurality of structures represented by Formula (b1). For example, it may be a compound having a structure in which at least one of R²⁰¹ to R²⁰³ of a compound represented by Formula (b1) is bonded directly or via a linking group to at least one of R²⁰¹ to R²⁰³ of a compound represented by Formula (b1).

Yet more preferred examples of the component (b1) include compounds (b1-1), (b1-2), and (b1-3), which are explained below.

The compound (b1-1) is an arylsulfonium compound in which at least one of R²⁰¹ to R²⁰³ of the Formula (b1) above is an aryl group having no greater than 20 carbon atoms, that is, a compound having arylsulfonium as a cation.

With regard to the arylsulfonium compound, all of R²⁰¹ to R²⁰³ may be aryl groups, or some of R²⁰¹ to R²⁰³ may be an aryl group and the rest may be an alkyl group having 1 to 20 carbon atoms or a cycloalkyl group having no greater than 20 carbon atoms.

Examples of the arylsulfonium compound include a triarylsulfonium compound, a diarylalkylsulfonium compound, an aryidialkylsulfonium compound, a diarylcycloalkylsulfonium compound, and an aryldicycloalkylsulfonium compound.

With regard to the aryl group of the arylsulfonium compound, an aryl group such as a phenyl group or a naphthyl group and a heteroaryl group such as an indole residue or a pyrrole residue are preferable, and a phenyl group and an indole residue are more preferable. When the aryl sulfonium compound has two or more aryl groups, two or more of the aryl groups may be identical to or different from each other.

The alkyl group that the arylsulfonium compound may have as necessary is preferably a straight-chain or branched alkyl group having 1 to 15 carbon atoms, and examples thereof include a methyl group, an ethyl group, a propyl group, an n-butyl group, a sec-butyl group, and a t-butyl group.

The cycloalkyl group that the arylsulfonium compound may have as necessary is preferably a cycloalkyl group having 3 to 15 carbon atoms, and examples thereof include a cyclopropyl group, a cyclobutyl group, and a cyclohexyl group.

The aryl group, the alkyl group, and the cycloalkyl group denoted by R²⁰¹ to R²⁰³ may have as a substituent an alkyl group (e.g. having 1 to 15 carbon atoms), a cycloalkyl group (e.g. having 3 to 15 carbon atoms), an aryl group (e.g. having 6 to 14 carbon atoms), an alkoxy group (e.g. having 1 to 15 carbon atoms), a halogen atom, a hydroxy group, or a phenylthio group. Preferred examples of the substituent include a straight-chain or branched alkyl group having 1 to 12 carbon atoms, a cycloalkyl group having 3 to 12 carbon atoms, and a straight-chain, branched, or cyclic alkoxy group having 1 to 12 carbon atoms, and the most preferable examples include an alkyl group having 1 to 4 carbon atoms and an alkoxy group having 1 to 4 carbon atoms. One of R²⁰¹ to R²⁰³ may be substituted or all thereof may be substituted. When R²⁰¹ to R²⁰³ are aryl groups, it is preferable for the substituent to be present at the p-position of the aryl group.

The compound (b1-2) is now explained.

The compound (b1-2) is a compound in which R²⁰¹ to R²⁰³ of Formula (b1) independently denote an organic group having no aromatic ring. The aromatic ring referred to here includes an aromatic ring containing a hetero atom.

The organic group having no aromatic ring denoted by R²⁰¹ to R²⁰³ preferably has 1 to 30 carbon atoms, and more preferably 1 to 20 carbon atoms.

The organic group may contain an oxo group or a carbonyloxy group.

R²⁰¹ to R²⁰³ preferably independently denote an alkyl group having 1 to 20 carbon atoms, a cycloalkyl group having no greater than 20 carbon atoms, an allyl group, or a vinyl group, more preferably a straight-chain, branched, or cyclic 2-oxoalkyl group having no greater than 20 carbon atoms or alkoxycarbonylmethyl group having no greater than 20 carbon atoms, and particularly preferably a straight-chain or branched 2-oxoalkyl group having no greater than 20 carbon atoms.

The alkyl group denoted by R²⁰¹ to R²⁰³ may be a straight-chain or branched, is preferably a straight-chain or branched alkyl group having 1 to 10 carbon atoms (e.g. a methyl group, an ethyl group, a propyl group, a butyl group, and a pentyl group), and is more preferably a straight-chain or branched 2-oxoalkyl group having no greater than 20 carbon atoms or an alkoxycarbonylmethyl group having no greater than 20 carbon atoms.

The cycloalkyl group denoted by R²⁰¹ to R²⁰³ may preferably be a cycloalkyl group having 3 to 10 carbon atoms (a cyclopentyl group, a cyclohexyl group, or a norbornyl group), and a cyclic 2-oxoalkyl group is more preferable.

The straight-chain, branched, or cyclic 2-oxoalkyl group denoted by R²⁰¹ to R²⁰³ may preferably be the above-mentioned alkyl group or cycloalkyl group in which there is >C═O at the 2-position.

Preferred examples of the alkoxy group of the alkoxycarbonylmethyl group denoted by R²⁰¹ to R²⁰³ include an alkoxy group having 1 to 5 carbon atoms (a methoxy group, an ethoxy group, a propoxy group, a butoxy group, and a pentoxy group).

R²⁰¹ to R²⁰³ may further be substituted with a halogen atom, an alkoxy group (e.g. having 1 to 5 carbon atoms), a hydroxyl group, a cyano group, or a nitro group.

The compound (b1-3) referred to is a compound represented by Formula (b1-3) below and is a compound having a phenacylsulfonium salt structure.

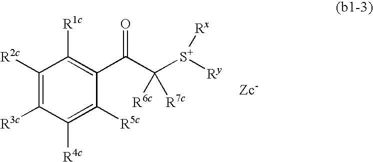

In Formula (b1-3), R^{1c} to R^{5c} independently denote a hydrogen atom, an alkyl group having 1 to 20 carbon atoms, a cycloalkyl group having no greater than 20 carbon atoms, an alkoxy group having no greater than 20 carbon atoms, or a halogen atom.

R^{6c} and R^{7c} independently denote a hydrogen atom, an alkyl group having 1 to 20 carbon atoms, or a cycloalkyl group having no greater than 20 carbon atoms.

R^{x} and R^{y} independently denote an alkyl group having 1 to 20 carbon atoms, a cycloalkyl group having no greater than 20 carbon atoms, an allyl group, or a vinyl group.

Any two or more of R^{1c} to R^{5c}, R^{6c} and R^{7c}, and R^{x} and R^{y} may be bonded together to form a ring structure.

Zc⁻ denotes a non-nucleophilic anion, and the same examples as those of the non-nucleophilic anion X⁻ in Formula (b1) may be cited.

The alkyl group denoted by R^{1c} to R^{7c} may be either a straight-chain alkyl group or a branched alkyl group, and preferred examples thereof include straight-chain and branched alkyl groups having 1 to 20 carbon atoms, and more preferably 1 to 12 carbon atoms (e.g. a methyl group, an ethyl group, a straight-chain or branched propyl group, a straight-chain or branched butyl group, and a straight-chain or branched pentyl group).

Preferred examples of the cycloalkyl group denoted by R^{1c} to R^{7c} include cycloalkyl groups having 3 to 8 carbon atoms (e.g. a cyclopentyl group and a cyclohexyl group).

The alkoxy group denoted by R^{1c} to R^{5c} may be any of a straight-chain, branched, or cyclic alkoxy group; examples thereof include alkoxy groups having 1 to 10 carbon atoms, and preferably straight-chain or branched alkoxy groups having 1 to 5 carbon atoms (e.g. a methoxy group, an ethoxy group, a straight-chain or branched propoxy group, a straight-chain or branched butoxy group, and a straight-chain or branched pentoxy group), and cyclic alkoxy groups having 3 to 8 carbon atoms (e.g. a cyclopentyloxy group and a cyclohexyloxy group).

Examples of the group formed by bonding any two or more of R^{1c} to R^{5c}, R^{6c} and R^{7c}, and R^{x} and R^{y} include a butylene group and a pentylene group. This cyclic structure may contain an oxygen atom, a sulfur atom, an ester bond, or an amide bond.

It is preferable for any one of R^{1c} to R^{5c} to be a straight-chain or branched alkyl group, a cycloalkyl group, or a straight-chain, branched, or cyclic alkoxy group, and it is more preferable that the sum of the number of carbon atoms of R^{1c} to R^{5c} is 2 to 15. This is preferable since the solvent solubility further improves and the occurrence of particles during storage is suppressed.

Examples of the alkyl groups and the cycloalkyl groups denoted by R^{x} and R^{y} may be the same as those of the alkyl groups and the cycloalkyl groups denoted by R^{1c} to R^{7c}.

R^{x} and R^{y} are preferably 2-oxoalkyl groups or alkoxycarbonylmethyl groups.

Examples of the 2-oxoalkyl group include a group in which the alkyl group or the cycloalkyl group denoted by R^{1c} to R^{5c} has >C═O at the 2-position.

Examples of the alkoxy group of the alkoxycarbonylmethyl group may be the same as those of the alkoxy group denoted by R^{1c} to R^{5c}.

R^{x} and R^{y} are preferably alkyl groups or cycloalkyl groups having 4 or more carbon atoms, more preferably alkyl groups or cycloalkyl groups having 6 or more carbon atoms, and yet more preferably 8 or more carbon atoms.

R²⁰⁴ to R²⁰⁷ in Formulae (b2) and (b3) independently denote an aryl group, an alkyl group, or a cycloalkyl group. X⁻ denotes a non-nucleophilic anion, and examples thereof include those that are the same as the non-nucleophilic anion X⁻ in Formula (b1).

The aryl group denoted by R²⁰⁴ to R²⁰⁷ is preferably a phenyl group or a naphthyl group, and more preferably a phenyl group.

The alkyl group denoted by R²⁰⁴ to R²⁰⁷ may be either a straight-chain or a branched alkyl group, and preferred examples thereof include straight-chain or branched alkyl groups having 1 to 10 carbon atoms (e.g. a methyl group, an ethyl group, a propyl group, a butyl group, and a pentyl group). Preferred examples of the cycloalkyl groups denoted by R²⁰⁴ to R²⁰⁷ include cycloalkyl groups having 3 to 10 carbon atoms (a cyclopentyl group, a cyclohexyl group, and a norbornyl group).

Examples of the substituents that are present on R²⁰⁴ to R²⁰⁷ include an alkyl group (e.g. having 1 to 15 carbon atoms), a cycloalkyl group (e.g. having 3 to 15 carbon atoms), an aryl group (e.g. having 6 to 15 carbon atoms), an alkoxy group (e.g. having 1 to 15 carbon atoms), a halogen atom, a hydroxy group, and a phenylthio group.

Examples of the compound that generates an acid when exposed to actinic light or radiation further include compounds represented by Formulae (b4), (b5), and (b6) below.

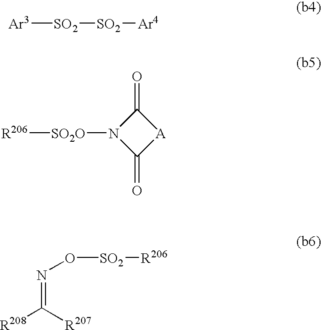

In Formula (b4) to (b6), Ar³ and Ar⁴ independently denote an aryl group having no more than 20 carbon atoms.

R²⁰⁶, R²⁰⁷ and R²⁰⁸ independently denote an alkyl group having 1 to 20 carbon atoms, a cycloalkyl group having no more than 20 carbon atoms, an aryl group having no more than 20 carbon atoms, or a cyano group.

A denotes an alkylene group having no more than 10 carbon atoms, an alkenylene group having no more than 10 carbon atoms, or an arylene group having no more than 10 carbon atoms.

Among the above-mentioned photo-acid generators, compounds represented by Formulae (b1) to (b3) are preferable.

Preferred compound examples (b-1) to (b-96) of the photo-acid generator used in the present invention are cited below, but the present invention should not be construed by being limited thereto.

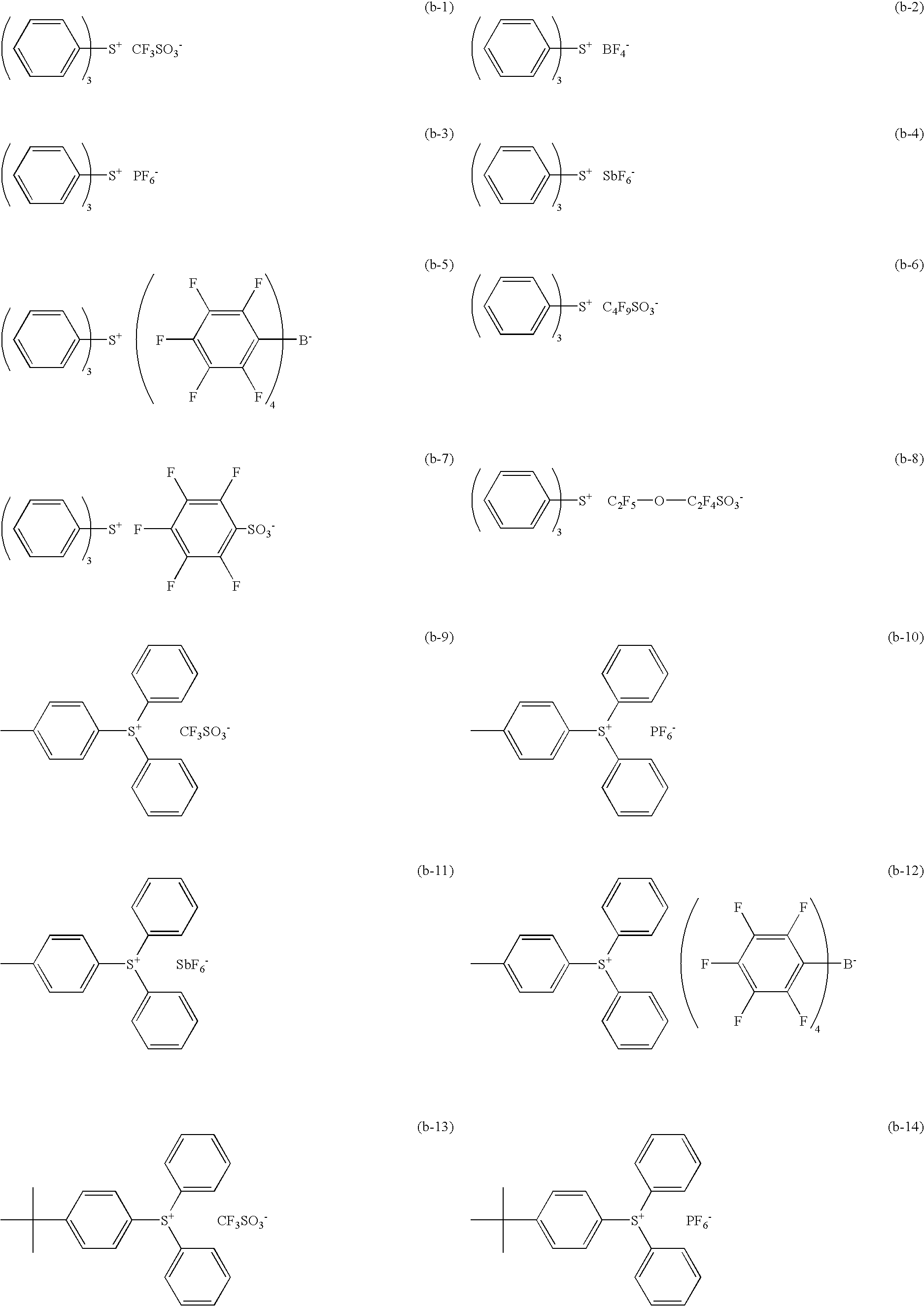

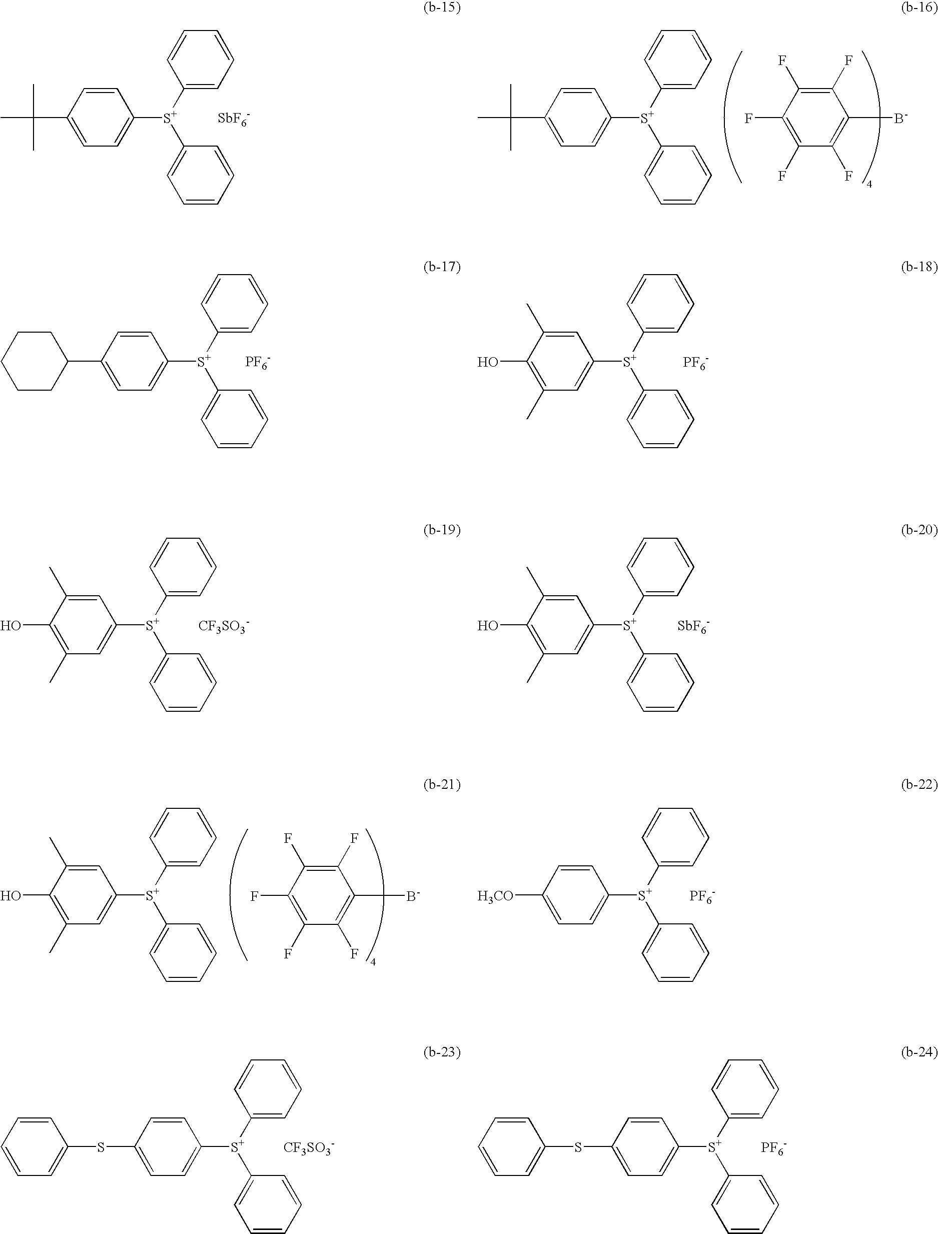

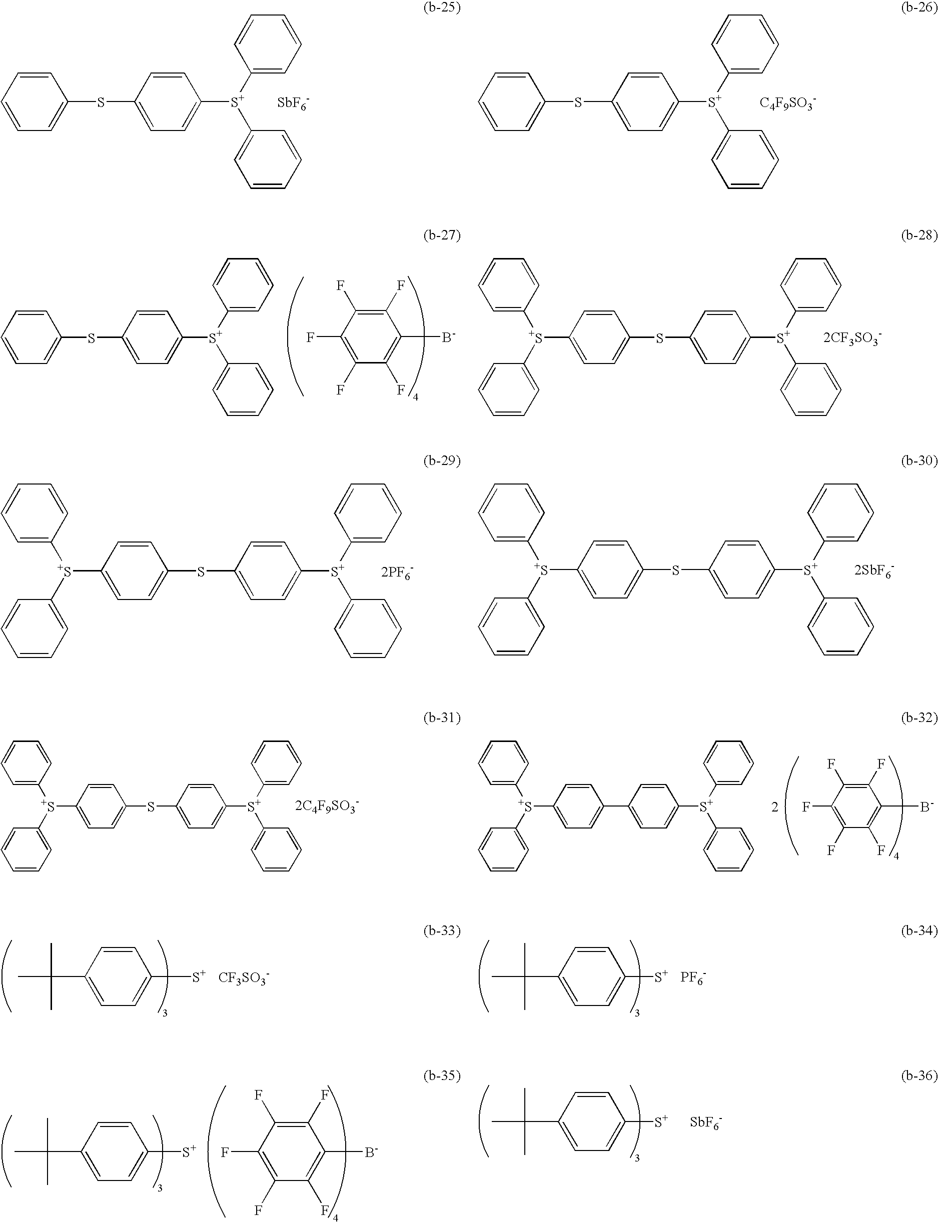

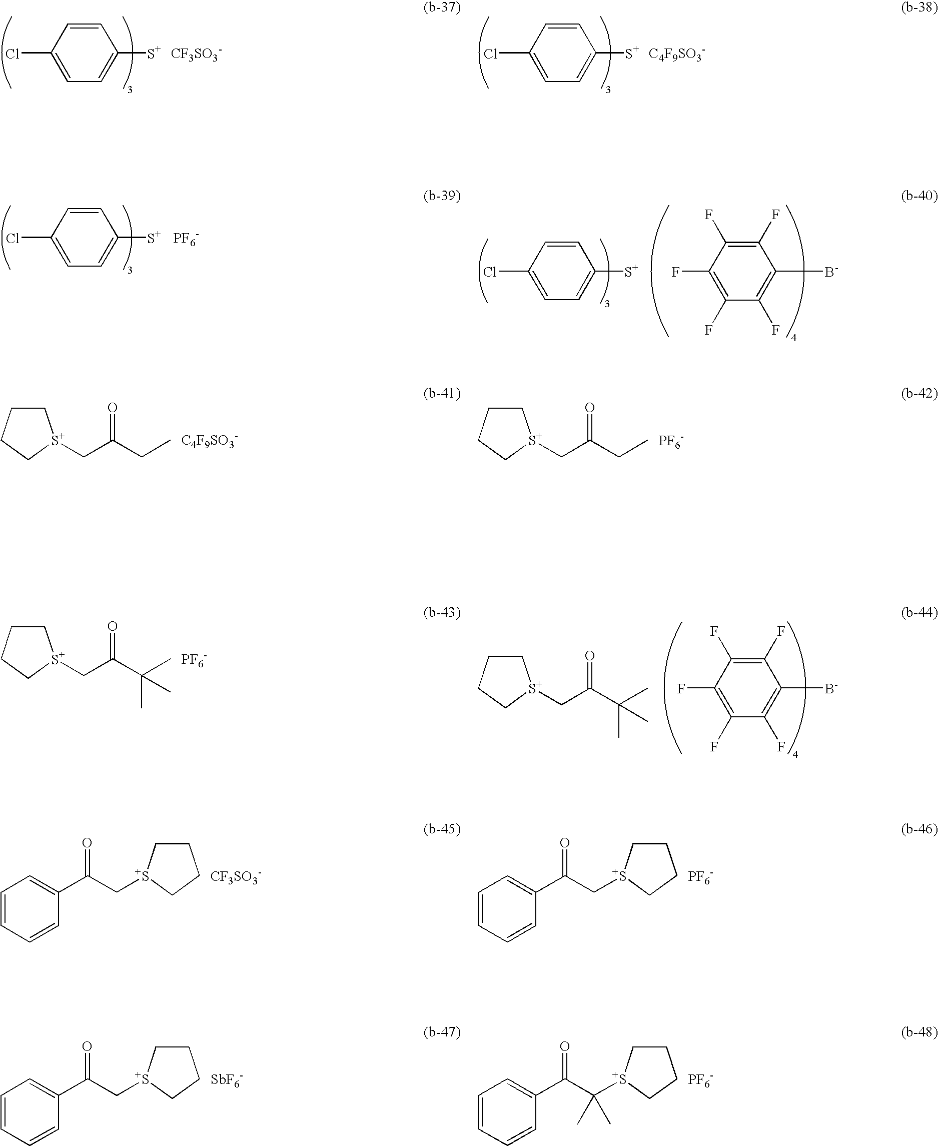

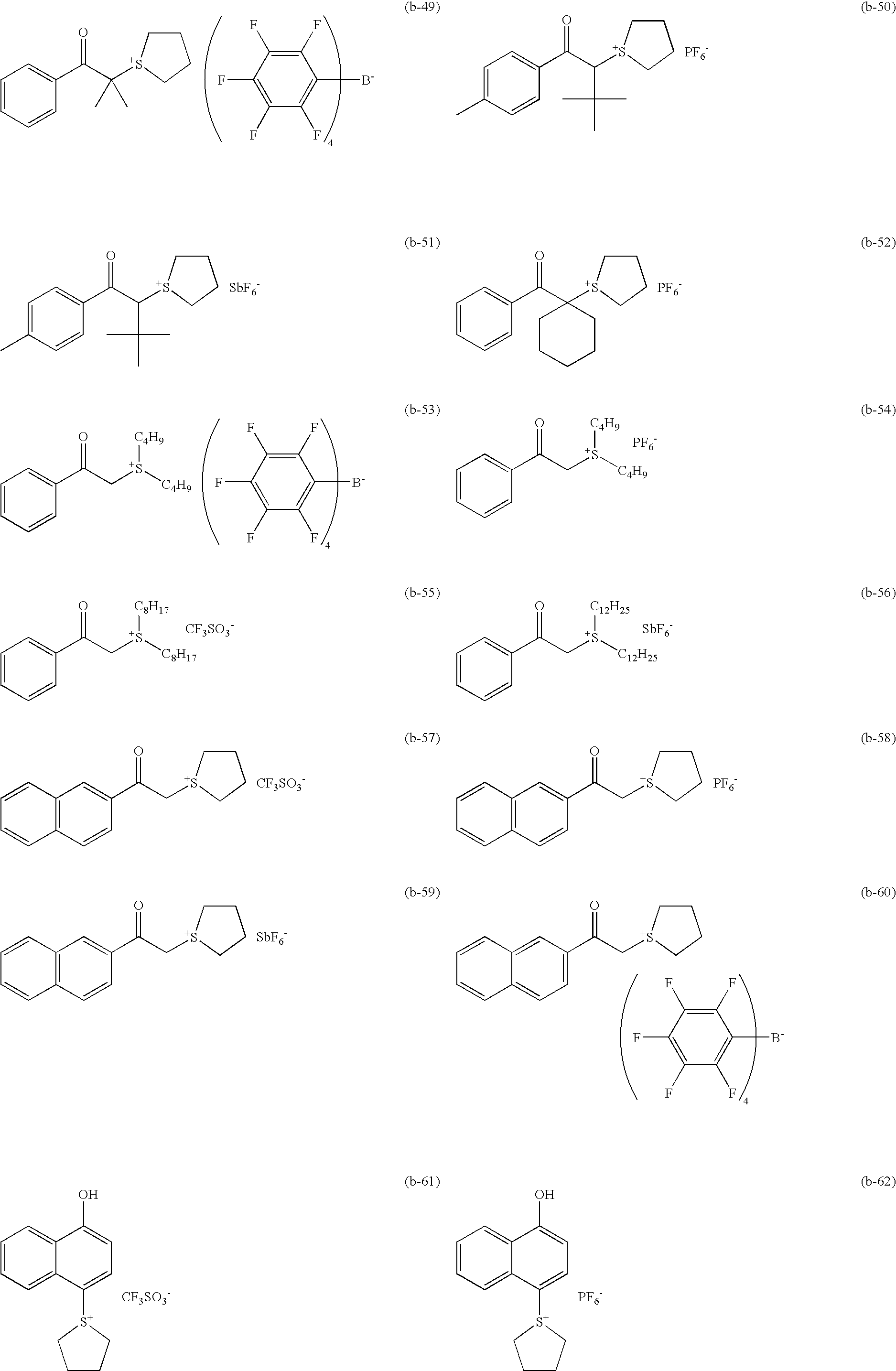

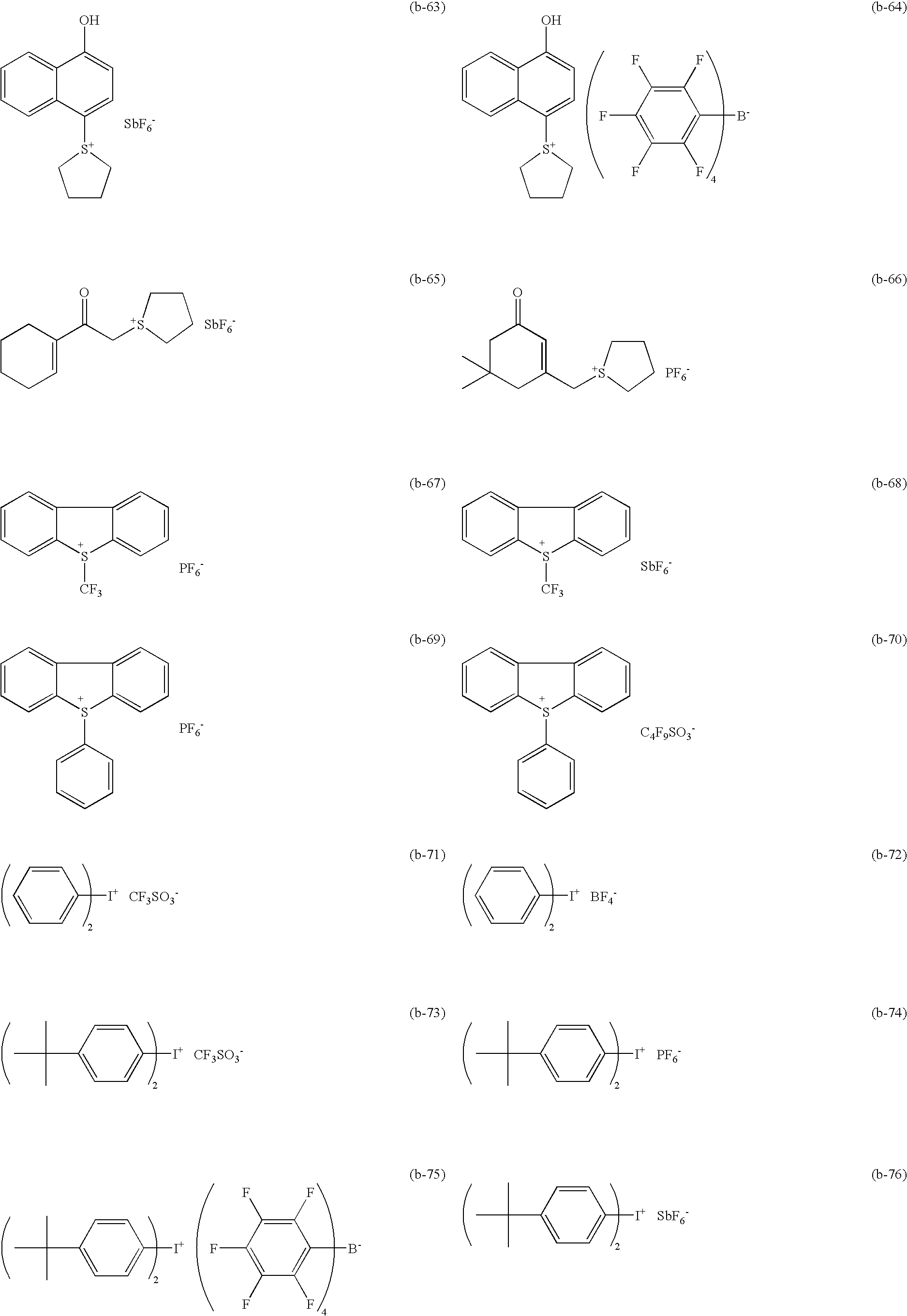

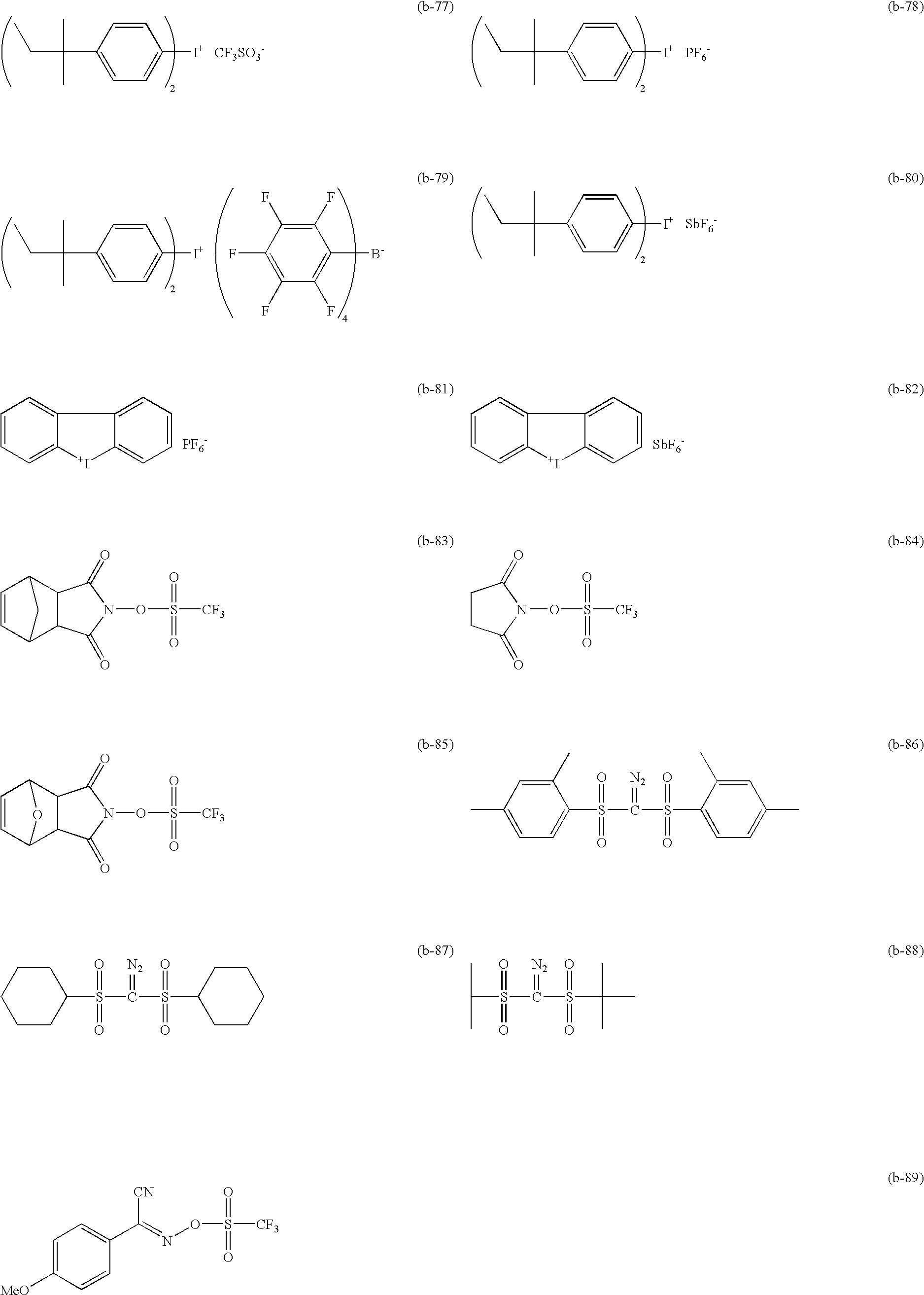

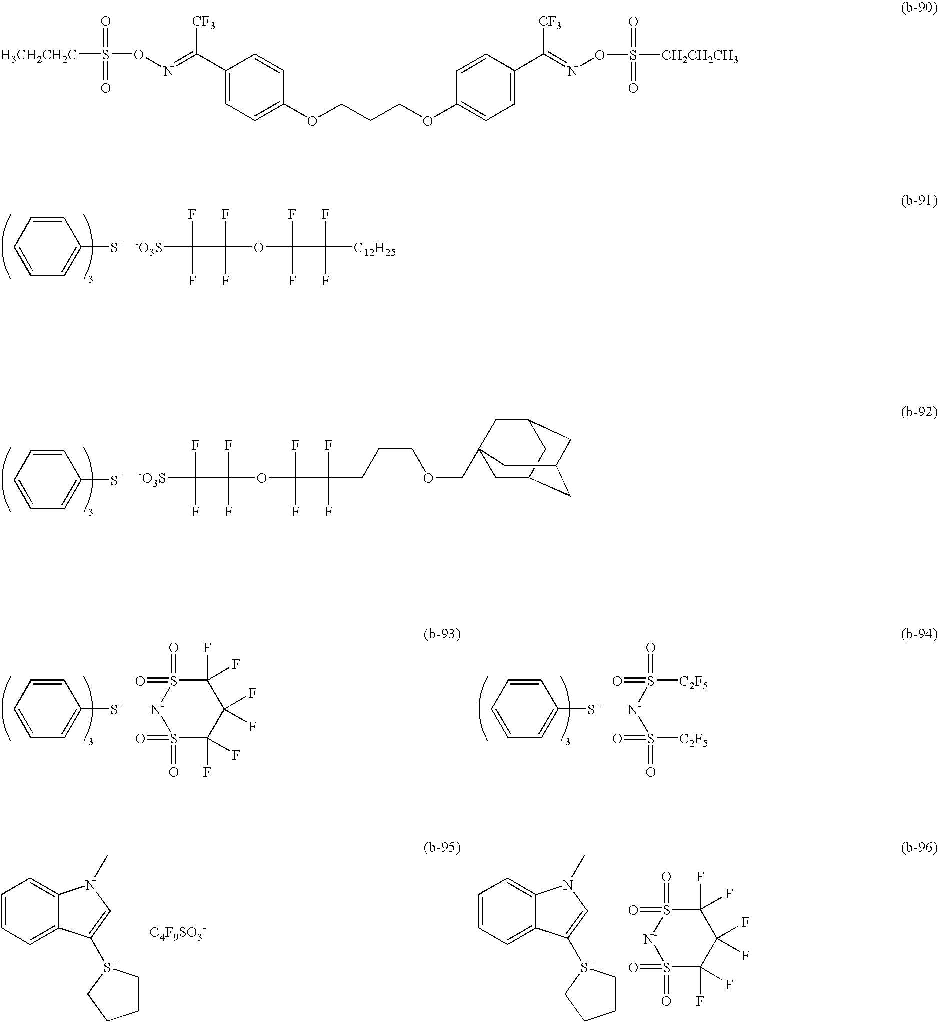

Furthermore, oxazole derivatives and s-triazine derivatives described in Paragraph Nos. (0029) to (0030) of JP-A-2002-122994 may suitably be used.

Onium salt compounds and sulfonate-based compounds cited as examples in Paragraph Nos. (0037) to (0063) of JP-A-2002-122994 may also be suitably used in the present invention.

The photo-acid generator may be used singly or in a combination of two or more types.

The content of the photo-acid generator in the photocurable coating composition of the present invention, on a photocurable coating composition solids content basis, is preferably 1 to 40 wt %, more preferably 3 to 30 wt %, yet more preferably 5 to 20 wt %, and most preferably 5 to 10 wt %.

When the content is within the above-mentioned range of values, the sensitivity is high, the non-tackiness (suppression of surface tackiness) is excellent, the viscosity of the photocurable coating composition is appropriate, and the surface smoothness is excellent.

The photo-acid generator used in the present invention preferably has a maximum absorption wavelength of no greater than 400 nm, and more preferably no greater than 360 nm. By setting the absorption wavelength in the UV region in this way a photocurable coating composition having high transparency can be obtained.

### (3) Other Components

### UV Absorber

In the present invention, a UV absorber may be used from the viewpoint of improving the weather resistance of an overprint obtained and preventing discoloration.

The UV absorbers include benzotriazole compounds described in JP-A-58-185677, JP-A-61-190537, JP-A-2-782, JP-A-5-197075 and JP-A-9-34057; benzophenone compounds described in JP-A-46-2784, JP-A-5-194483 and U.S. Pat. No. 3,214,463; cinnamic acid compounds described in JP-B-48-30492, JP-B-56-21141 and JP-A-10-88106; triazine compounds described in JP-A-4-298503, JP-A-8-53427, JP-A-8-239368, JP-A-10-182621 and JP-W-8-501291 (the term “JP-W” as used herein means an unexamined published international patent application); compounds described in Research Disclosure No. 24239; and compounds represented by stilbene and benzoxazole compounds, which absorb ultraviolet rays to emit fluorescence, the so-called fluorescent brightening agents. The amount thereof added is appropriately selected according to the intended application, and it is generally on the order of 0.5 to 15 wt % on the basis of the solids content in the ink composition.

### Sensitizer

In the present invention, the photocurable coating composition may contain a sensitizer as necessary for the purpose of improving the acid generating efficiency of the photo-acid generator and increasing the photosensitive wavelength.

Any sensitizer may be used as long as the photo-acid generator is sensitized by virtue of an electron transfer mechanism or an energy transfer mechanism. Preferred examples thereof include aromatic polycondensed compounds such as anthracene, 9,10-dialkoxyanthracene, pyrene, and perylene, aromatic ketone compounds such as acetophenone, benzophenone, thioxanthone, and Michler's ketone, and heterocyclic compounds such as phenothiazine and N-aryloxazolidinone.

The amount thereof added is appropriately selected according to the intended application, and it is generally used at 0.01 to 10 mol % relative to the photo-acid generator, and preferably 0.1 to 5 mol %.

### Antioxidant

In the present invention, in order to improve the stability of the photocurable coating composition, an antioxidant may be added.

Examples of the antioxidant include those described in Laid-open European Patent Nos. 223739, 309401, 309402, 310551, 310552, and 459-416, Laid-open German Patent No. 3435443, JP-A-54-48535, JP-A-62-262047, JP-A-63-113536, JP-A-63-163351, JP-A-2-262654, JP-A-2-71262, JP-A-3-121449, JP-A-5-61166, JP-A-5-119449, and U.S. Pat. Nos. 4,814,262 and 4,980,275.

The amount thereof added is appropriately selected according to the intended application, and it is preferably on the order of 0.1 to 10 wt % on the basis of the solids content in the photocurable coating composition.

### Antifading Agent

In the present invention, the photocurable coating composition of the present invention may employ various organic and metal complex antifading agents.

The organic antifading agents include hydroquinones, alkoxyphenols, dialkoxyphenols, phenols, anilines, amines, indanes, chromans, alkoxyanilines, and heterocycles.

And the metal complex antifading agents include nickel complexes and zinc complexes. More specifically, there can be used compounds described in patents cited in Research Disclosure, No. 17643, Items VII-I to J, ibid., No. 15162, ibid., No. 18716, page 650, left-hand column, ibid., No. 36544, page 527, ibid., No. 307105, page 872, and ibid., No. 15162, and compounds contained in general formulae and compound examples of typical compounds described in JP-A-62-215272, pages 127 to 137.

The amount thereof added is appropriately selected according to the intended application, and it is preferably on the order of 0.1 to 10 wt % on the basis of the solids content in the photocurable coating composition.

### Solvent

It is also effective to add a trace amount of organic solvent to the photocurable coating composition of the present invention in order to improve the adhesion to a recording medium.

Examples of the solvent include ketone-based solvents such as acetone, methyl ethyl ketone, and diethyl ketone, alcohol-based solvents such as methanol, ethanol, 2-propanol, 1-propanol, 1-butanol, and tert-butanol, chlorine-based solvents such as chloroform and methylene chloride, aromatic-based solvents such as benzene and toluene, ester-based solvents such as ethyl acetate, butyl acetate, and isopropyl acetate, ether-based solvents such as diethyl ether, tetrahydrofuran, and dioxane, and glycol ether-based solvents such as ethylene glycol monomethyl ether and ethylene glycol dimethyl ether.

In this case, it is effective if the amount thereof added is in a range that does not cause problems with the solvent resistance or the VOC, and the amount is preferably in the range of 0.1 to 5 wt % relative to the total amount of the photocurable coating composition, and more preferably 0.1 to 3 wt %.

### Polymer Compound

In the present invention, in order to adjust physical properties of a film formed by curing, various types of polymer compound may be added.

Examples of the polymer compounds include acrylic polymers, polyvinylbutyral resins, polyurethane resins, polyamide resins, polyester resins, epoxy resins, phenol resins, polycarbonate resins, polyvinylformal resins, shellac, vinylic resins, acrylic resins, rubber-based resins, waxes, and other natural resins. They may be used in a combination of two or more types. Among these, a vinylic copolymer obtained by copolymerization of an acrylic monomer is preferable.

### Surfactant

The photocurable coating composition of the present invention may contain a surfactant.

As the surfactant, those described in JP-A-62-173463 and JP-A-62-183457 can be cited. Examples thereof include anionic surfactants such as dialkylsulfosuccinic acid salts, alkylnaphthalenesulfonic acid salts, and fatty acid salts, nonionic surfactants such as polyoxyethylene alkyl ethers, polyoxyethylene alkyl allyl ethers, acetylene glycols, and polyoxyethylene/polyoxypropylene block copolymers, and cationic surfactants such as alkylamine salts and quaternary ammonium salts. Instead of the surfactant, an organofluoro compound may be used. The organofluoro compound is preferably hydrophobic. Examples of the organofluoro compound include fluorine-based surfactants, oil-like fluorine-based compounds (e.g. a fluorine oil), and solid fluorine compounds resin (e.g. tetrafluoroethylene resin), and those described in JP-B-57-9053 (8th to 17th columns) and JP-A-62-135826.

In addition to the above, the composition may contain as necessary, for example, a leveling additive, a matting agent, a wax for adjusting film physical properties, or a tackifier in order to improve the adhesion to a recording medium such as polyolefin or PET, the tackifier not inhibiting polymerization.

Specific examples of the tackifier include high molecular weight tacky polymers described on pp. 5 and 6 of JP-A-2001-49200 (e.g. a copolymer formed from an ester of (meth)acrylic acid and an alcohol having an alkyl group with 1 to 20 carbon atoms, an ester of (meth)acrylic acid and an alicyclic alcohol having 3 to 14 carbon atoms, or an ester of (meth)acrylic acid and an aromatic alcohol having 6 to 14 carbon atoms), and a low molecular weight tackifying resin having a polymerizable unsaturated bond.

### Properties of Photocurable Coating Composition

Preferred physical properties of the photocurable coating composition of the present invention are now explained.

When used as a photocurable coating composition, while taking into consideration coating properties, the viscosity at 25° C. to 30° C. is preferably 5 to 100 mPa·s, and more preferably 7 to 75 mPa·s.

The compositional ratio of the photocurable coating composition of the present invention is preferably adjusted as appropriate so that the viscosity is in the above range.

Setting the viscosity at 25° C. to 30° C. at the above value enables an overprint having an overprint layer with excellent non-tackiness (no surface tackiness) and excellent surface smoothness to be obtained.

The surface tension of the photocurable coating composition of the present invention is preferably 16 to 40 mN/m, and more preferably 18 to 35 mN/m.

### Overprint and Process for Producing Same

The overprint of the present invention has, on a printed material, an overprint layer in which the coating composition of the present invention is photocured.

The overprint referred to here is at least one overprint layer formed on the surface of a printed material obtained by a printing method such as electrophotographic printing, inkjet printing, screen printing, flexographic printing, lithographic printing, intaglio printing, or relief printing.

The overprint layer in the overprint of the present invention may be formed on part of a printed material or may be formed on the entire surface of a printed material, and in the case of a double-side printed material, it is preferable to form the overprint layer on the entire surface of a printing substrate on both sides. Furthermore, needless to say, the overprint layer may be formed on an unprinted area of a printed material.

A printed material used for the overprint of the present invention is preferably an electrophotographically printed material. Forming an overprint layer, which is a cured layer of the coating composition of the present invention, on an electrophotographically printed material enables an overprint that has excellent non-tackiness, surface smoothness, and gloss and is visually similar to a silver halide photographic print to be obtained.

Furthermore, since the overprint of the present invention has excellent non-tackiness, even when a plurality of prepared overprints of the present invention are superimposed on each other and stored for a long period of time, the overprints do not stick to each other, and the storage properties are excellent.

The thickness of the overprint layer in the overprint of the present invention is preferably 1 to 10 μm, and more preferably 3 to 6 μm.

A method for measuring the thickness of the overprint layer is not particularly limited, but a preferred example thereof include a measurement method in which a cross section of an overprint is examined using an optical microscope, etc.

A process for producing an overprint of the present invention preferably comprises a step of preparing a printed material by printing on a printing substrate, a step of coating the printed material with a photocurable composition and a step of photocuring the photocurable composition.

Furthermore, the process for producing an overprint of the present invention preferably comprises a step of generating an electrostatic latent image on a latent image support, a step of developing the electrostatic latent image using a toner, a step of obtaining an electrophotographically printed material by transferring the developed electrostatic image onto a printing substrate, a step of coating the electrophotographically printed material with the photocurable coating composition of the present invention, and a step of photocuring the coating composition.

The printing substrate is not particularly limited, and a known substrate may be used, but an image receiving paper is preferable, plain paper or coated paper is more preferable, and coated paper is yet more preferable. As the coated paper, a double-sided coated paper is preferable since a full color image can be attractively printed on both sides. When the printing substrate is paper or a double-sided coated paper, the paper weight is preferably 20 to 200 g/m², and more preferably 40 to 160 g/m².

A method for developing an image in the electrophotographic process is not particularly limited, and any method may be selected from methods known to a person skilled in the art. Examples thereof include a cascade method, a touch down method, a powder cloud method, and a magnetic brush method.

Furthermore, examples of a method for transferring a developed image to a printing substrate include a method employing a corotron or a bias roll.

A fixing step of fixing an image in the electrophotographic process may be carried out by various appropriate methods. Examples thereof include flash fixing, thermal fixing, pressure fixing, and vapor fusing.

The image formation method, equipment, and system in the electrophotographic process are not particularly limited, and known ones may be used. Specific examples are described in the U.S. patents below.

U.S. Pat. Nos. 4,585,884, 4,584,253, 4,563,408, 4,265,990, 6,180,308, 6,212,347, 6,187,499, 5,966,570, 5,627,002, 5,366,840, 5,346,795, 5,223,368, and 5,826,147.

In order to apply the photocurable coating composition, a commonly used liquid film coating device may be used. Specific examples thereof include a roller coater, a rod coater, a blade, a wire-wound bar, a dip coater, an air knife, a curtain coater, a slide coater, a doctor knife, a screen coater, a gravure coater such as an offset gravure coater, a slot coater, and an extrusion coater. These devices may be used in the same manner as normal, and examples thereof include direct and reverse roll coating, blanket coating, dampener coating, curtain coating, lithographic coating, screen coating, and gravure coating. In a preferred embodiment, application and curing of the coating composition of the present invention are carried out using 2 or 3 roll coaters and UV curing stations.

Moreover, when coating or curing the coating composition of the present invention, heating may be carried out as necessary.

The coat weight of the coating composition of the present invention is preferably in the range of 1 to 10 g/m² as a weight per unit area, and more preferably 3 to 6 g/m².

Furthermore, the amount per unit area of an overprint layer formed in the overprint of the present invention is preferably in the range of 1 to 10 g/m², and more preferably 3 to 6 g/m².

As an energy source used for initiating polymerization of the polymerizable compound contained in the coating composition of the present invention, for example, one having actinism (actinic radiation) such as radiation having a wavelength in the UV or visible spectrum can be cited. Polymerization by irradiation with actinic radiation is excellent for initiating polymerization and regulating the speed of polymerization.

As a preferred actinic radiation source, for example, there are a mercury lamp, a xenon lamp, a carbon arc lamp, a tungsten filament lamp, a laser, and sunlight.

It is preferable to carry out irradiation using a high speed conveyor (preferably 15 to 70 m/min) under irradiation with UV rays (UV light irradiation) using a medium pressure mercury lamp, and in this case UV light irradiation is preferably carried out at a wavelength of 200 to 500 nm for less than 1 sec. Preferably, the speed of the high speed conveyor is 15 to 35 m/min, and UV light having a wavelength of 200 to 450 nm is applied for 10 to 50 milliseconds (ms). The emission spectrum of a UV light source normally overlaps the absorption spectrum of a UV polymerization initiator. Depending on the situation, curing equipment used may include, without being limited to, a reflection plate for focusing or diffusing UV light or a cooling system for removing heat generated by a UV light source.

### Properties of Cured Material Formed by Curing Photocurable Coating Composition

A cured material formed by curing the photocurable coating composition of the present invention by irradiation with UV rays (UV light irradiation) preferably has substantially no absorption in the visible region. ‘Having substantially no absorption in the visible region’ means either having no absorption in the visible region of 400 to 700 nm or having only a level of absorption in the visible region that does not cause any problem as a photocurable coating. Specifically, a 5 μm optical path length transmittance of the cured material formed by coating composition in the wavelength region of 400 to 700 nm is at least 70%, and preferably at least 80%.

In accordance with the present invention, there can be provided a photocurable composition giving excellent surface smoothness, non-tackiness (suppression of surface tackiness), and suppression of odor, an overprint obtained by using the photocurable composition, and a process for producing same.

### EXAMPLES

The present invention is explained in further detail by reference to Examples below, but the present invention is not limited to these Examples.

### Example 1

The components below were stirred using a stirrer to give photocurable overprint composition 1.

| | |
|---|---|
| TPS-TF (Ph₃-S⁺CF₃SO₃⁻: Toyo Gosei Co., Ltd.) | 7 wt % |
| Anthracene (Aldrich) | 3 wt % |
| 3,7-Bis(3-oxetanyl)-5-oxanonane (OXT-221: Toagosei Co., Ltd.) | 10 wt % |
| 3-Ethyl-3-phenoxymethyloxetane (OXT-211: Toagosei | 10 wt % |
| Co., Ltd.) | |
| Compound (A-1) | 70 wt % |

### Example 2 to 10 and 21

In Examples 2 to 10 and 21, photocurable overprint compositions 2 to 10 and 21 were obtained in the same manner as in Example 1 except that compound (A-1) was changed to a compound shown in Table 1.

### Example 11

The components below were stirred using a stirrer to give photocurable overprint composition 11.

| | |
|---|---|
| TPS-TF (Ph₃-S⁺CF₃SO₃⁻: Toyo Gosei Co., Ltd.) | 7 wt % |
| Anthracene (Aldrich) | 3 wt % |
| (3′,4′-Epoxycyclohexane)methyl-3′,4′-Epoxycyclohexyl- | 20 wt % |
| carboxylate (CELLOXIDE 2021: DAICEL CHEMICAL | |
| INDUSTRIES, Ltd.) | |
| 3,7-Bis(3-oxetanyl)-5-oxanonane (OXT-221: Toagosei Co., Ltd.) | 10 wt % |
| 3-Ethyl-3-phenoxymethyloxetane (OXT-211: Toagosei | 20 wt % |
| Co., Ltd.) | |
| Compound (A-1) | 40 wt % |

### Example 12 to 20 and 22

In Examples 12 to 20 and 22, photocurable overprint compositions 12 to 20 and 22 were obtained in the same manner as in Example 11 except that compound (A-1) was changed to a compound shown in Table 1.

### Comparative Example 1

The components below were stirred using a stirrer to give Comparative photocurable overprint composition 1.

| | |
|---|---|
| TPS-TF (Ph₃-S⁺CF₃SO₃⁻: Toyo Gosei Co., Ltd.) | 7 wt % |
| Anthracene (Aldrich) | 3 wt % |
| 3,7-Bis(3-oxetanyl)-5-oxanonane (OXT-221: Toagosei Co., Ltd.) | 10 wt % |
| 3-Ethyl-3-phenoxymethyloxetane (OXT-211: Toagosei | 80 wt % |
| Co., Ltd.) | |

### Comparative Example 2

The components below were stirred using a stirrer to give Comparative photocurable overprint composition 2.

| | |
|---|---|
| TPS-TF (Ph₃-S⁺CF₃SO₃⁻: Toyo Gosei Co., Ltd.) | 7 wt % |
| Anthracene (Aldrich) | 3 wt % |
| 3,7-Bis(3-oxetanyl)-5-oxanonane (OXT-221: Toagosei Co., Ltd.) | 80 wt % |
| 3-Ethyl-3-phenoxymethyloxetane (OXT-211: Toagosei | 10 wt % |
| Co., Ltd.) | |

### Comparative Example 3

The components below were stirred using a stirrer to give Comparative photocurable overprint composition 3.

| | |
|---|---|
| TPS-TF (Ph₃-S⁺CF₃SO₃⁻: Toyo Gosei Co., Ltd.) | 7 wt % |
| Anthracene (Aldrich) | 3 wt % |
| (3′,4′-Epoxycyclohexane)methyl-3′,4′-Epoxycyclohexyl- | 20 wt % |
| carboxylate (CELLOXIDE 2021: DAICEL CHEMICAL | |
| INDUSTRIES, Ltd.) | |
| 3,7-Bis(3-oxetanyl)-5-oxanonane (OXT-221: Toagosei Co., Ltd.) | 10 wt % |
| 3-Ethyl-3-phenoxymethyloxetane (OXT-211: Toagosei | 60 wt % |
| Co., Ltd.) | |

### Comparative Example 4

The components below were stirred using a stirrer to give Comparative photocurable overprint composition 4.

| | |
|---|---|
| TPS-TF (Ph₃-S⁺CF₃SO₃⁻: Toyo Gosei Co., Ltd.) | 7 wt % |
| Anthracene (Aldrich) | 3 wt % |
| (3′,4′-Epoxycyclohexane)methyl-3′,4′-Epoxycyclohexyl- | 20 wt % |
| carboxylate (CELLOXIDE 2021: DAICEL CHEMICAL | |
| INDUSTRIES, Ltd.) | |
| 3,7-Bis(3-oxetanyl)-5-oxanonane (OXT-221: Toagosei Co., Ltd.) | 50 wt % |
| 3-Ethyl-3-phenoxymethyloxetane (OXT-211: Toagosei | 20 wt % |
| Co., Ltd.) | |

### Evaluation of Performance

The photocurable overprint compositions obtained were subjected to evaluation of their performance by the methods below. The evaluation results are shown in Table 1 below.

### Evaluation of Surface Smoothness (Leveling Properties)

An electrophotographically printed material, obtained using double-sided coated paper, output from a DC8000 digital printer manufactured by Fuji Xerox Co., Ltd. was coated on one side at a film thickness of 5 g/m² using an SG610V UV varnish coater manufactured by Shinano Kenshi Co., Ltd. The condition of the surface of the coated printed material was visually evaluated in terms of the occurrence of longitudinal lines. The evaluation criteria are shown below.

Excellent: no longitudinal lines.
Good: slight longitudinal lines remained.
Poor: many longitudinal lines observed.

### Evaluation of Non-Tackiness (Suppression of Surface Tackiness)

An electrophotographically printed material obtained using double-sided coated paper output from a DC8000 digital printer manufactured by Fuji Xerox Co., Ltd. was coated on one side with a coating composition at a film thickness of 5 g/m² using a bar coater, and a film coating thus obtained was exposed at 120 mJ/cm² with an illumination intensity of 1.0 W/cm² using a UV lamp (LC8) manufactured by Hamamatsu Photonics K.K., thus giving an overprint sample. The non-tackiness after exposure was evaluated by touch. Evaluation criteria are shown below.

Excellent: no tackiness
Good: almost no tackiness
Fair: slight tackiness
Poor: tackiness

### Evaluation of Odor

An electrophotographically printed material, obtained using double-sided coated paper, output from a DC8000 digital printer manufactured by Fuji Xerox Co., Ltd. was coated on one side with the coating composition at a film thickness of 5 g/m² using an SG610V UV varnish coater manufactured by Shinano Kenshi Co., Ltd., and then allowed to stand for 1 hour, a printed material thus obtained was subjected to sensory evaluation by sensing odor, and the level of odor was evaluated according to the criteria below.

Evaluation was carried out by eight expert panelists using the criteria below (evaluation points).

### Evaluation Criteria (Evaluation Points):

5 (points): 8 out of 8 people recognized effect in reducing odor.
4 (points): 6 to 7 out of 8 people recognized effect in reducing odor.
3 (points): 4 to 5 out of 8 people recognized effect in reducing odor.
2 (points): 1 to 3 out of 8 people recognized effect in reducing odor.
1 (point): effect in reducing odor was not recognized.

When the number of evaluation points was at least 4, it was considered that there would be no problem in practice.

TABLE 1

| | | Surface | | |
|---|---|---|---|---|
| Ex./Comp. Ex. | Compound | smoothness | Non-tackiness | Odor |
| Ex. 1 | A-1 | Excellent | Excellent | 5 |
| Ex. 2 | A-2 | Excellent | Excellent | 5 |
| Ex. 3 | A-4 | Excellent | Excellent | 5 |
| Ex. 4 | A-8 | Excellent | Excellent | 5 |
| Ex. 5 | A-9 | Excellent | Excellent | 5 |
| Ex. 6 | A-10 | Excellent | Excellent | 5 |
| Ex. 7 | A-11 | Excellent | Excellent | 5 |
| Ex. 8 | A-13 | Excellent | Excellent | 4 |
| Ex. 9 | A-15 | Excellent | Excellent | 4 |
| Ex. 10 | A-16 | Excellent | Excellent | 4 |
| Ex. 11 | A-1 | Excellent | Good | 5 |
| Ex. 12 | A-3 | Excellent | Good | 5 |
| Ex. 13 | A-5 | Excellent | Good | 5 |
| Ex. 14 | A-6 | Excellent | Good | 5 |
| Ex. 15 | A-7 | Excellent | Good | 5 |
| Ex. 16 | A-11 | Excellent | Good | 5 |
| Ex. 17 | A-12 | Excellent | Good | 5 |
| Ex. 18 | A-14 | Excellent | Good | 4 |
| Ex. 19 | A-16 | Excellent | Good | 4 |
| Ex. 20 | A-17 | Excellent | Good | 4 |
| Ex. 21 | A-19 | Excellent | Good | 4 |
| Ex. 22 | A-19 | Excellent | Fair | 4 |
| Comp. Ex. 1 | — | Excellent | Poor | 1 |
| Comp. Ex. 2 | — | Poor | Good | 4 |
| Comp. Ex. 3 | — | Good | Fair | 2 |
| Comp. Ex. 4 | — | Poor | Good | 2 |

### Example 23

22 sheets of printed material were prepared by electrophotographically printing full color images, each having a few frames, on both sides of A4 double-sided coated paper (paper weight 100 g/m²), both sides of the printed materials were coated with the photocurable overprint compositions prepared in Examples 1 to 22 above by the same method as in Example 1 at a coat weight of 5 g/m², and then irradiated with UV rays, thus giving overprints. When they were bound to give a photo album, a photo album giving the same visibility as that given by a silver halide photographic print was obtained.

### Example 24

22 sheets of printed material were prepared by electrophotographically printing a full color image including a menu photograph and text on both sides of substantially A3 double-sided coated paper (paper weight 100 g/m²), both sides of the printed materials were coated with the photocurable overprint compositions prepared in Examples 1 to 22 above by the same method as in Example 1 at a coat weight of 5 g/m² per side, and then irradiated with UV rays, thus giving overprints on both sides. When they were bound to give a restaurant menu, a restaurant menu giving the same visibility as that given by a silver halide photographic print was obtained.

In Examples 1 to 22 above, the amount of overprint layer formed by coating one side of a printing substrate with a photocurable overprint composition at a coat weight of 5 g/m² and curing it was 5 g/m² in each case.

Furthermore, the thickness of the overprint layer thus formed was about 5 μm in each case. The thickness of the overprint layer thus formed was measured by examining a cross section of the overprint using an optical microscope.

When the transmittance at an optical path length of 5 μm of the photocurable overprint compositions used in Examples 1 to 22 was measured, the transmittance was 80% over the whole wavelength region of 400 nm to 700 nm in all cases.

When the transmittance at an optical path length of 5 μm of the cured material formed by the photocurable overprint compositions used in Examples 1 to 21 was measured, the transmittance was 80% over the whole wavelength region of 400 nm to 700 nm in all cases.

What is claimed is:

1. A process for producing an overprint, the process comprising:
a step of preparing a printed material by printing on a printing substrate;
a step of coating the printed material with a photocurable composition; and
a step of photocuring the photocurable composition;
the photocurable composition comprising (1) a bridged ring hydrocarbon group-containing cationically polymerizable compound and (2) a photo-acid generator.

2. The process for producing an overprint according to claim 1, wherein the cationically polymerizable compound comprises an epoxy group, an oxetanyl group, or a vinyl ether group.

3. The process for producing an overprint according to claim 1, wherein the bridged ring hydrocarbon group is a bicyclo ring or a tricyclo ring.

4. The process for producing an overprint according to claim 1, wherein the cationically polymerizable compound is a compound in which the bridged ring hydrocarbon group and a cationically polymerizable group are bonded via a divalent linking group, and the divalent linking group is a group selected from the group consisting of a single bond, an alkylene group having 1 to 6 carbon atoms, an ether bond, a carbonyl group, a carboxylic acid ester bond, and a group that is formed by combining the above.

5. The process for producing an overprint according to claim 1, wherein the photocurable composition comprises, in addition to the cationically polymerizable compound, at least one compound selected from the group consisting of an epoxy compound, an oxetane compound, and a vinyl ether compound that do not have a bridged ring hydrocarbon group.

6. The process for producing an overprint according to claim 1, wherein the photocurable composition has substantially no absorption in the visible region.

7. The process for producing an overprint according to claim 1, wherein the printing is electrophotographic printing, and the printed material is an electrophotographically printed material.

8. The process for producing an overprint according to claim 7, wherein the electrophotographically printed material is an electrophotographically printed material having a fuser oil layer.

9. The process for producing an overprint according to claim 1, wherein the amount of cured photocurable composition formed on the printed material is 1 to 10 g/m².

10. The process for producing an overprint according to claim 1, wherein the photocurable composition cured on the printed material has a thickness of 1 to 10 μm.

11. An overprint produced by the process for producing an overprint according to claim 1.

12. A photocurable composition comprising:
(1) a bridged ring hydrocarbon group-containing cationically polymerizable compound; and
(2) a photo-acid generator.

13. The photocurable composition according to claim 12, wherein the cationically polymerizable compound comprises an epoxy group, an oxetanyl group, or a vinyl ether group.

14. The photocurable composition according to claim 12, wherein the bridged hydrocarbon group is a bicyclo ring or a tricyclo ring.

15. The photocurable composition according to claim 12, wherein the cationically polymerizable compound is a compound in which the bridged hydrocarbon group and a cationically polymerizable group are bonded via a divalent linking group, and the divalent linking group is a group selected from the group consisting of a single bond, an alkylene group having 1 to 6 carbon atoms, an ether bond, a carbonyl group, a carboxylic acid ester bond, and a group that is formed by combining the above.

16. The photocurable composition according to claim 12, wherein the photocurable composition comprises, in addition to the cationically polymerizable compound, at least one compound selected from the group consisting of an epoxy compound, an oxetane compound, and a vinyl ether compound that do not have a bridged ring hydrocarbon group.

17. The photocurable composition according to claim 12, wherein it has substantially no absorption in the visible region.
